(19) United States
(12) Patent Application Publication
(10) Pub. No.: US 2026/0158996 A1
(43) Pub. Date: Jun. 11, 2026

(54) OSG REAR-VIEW MIRROR SYSTEM

(71) Applicant: Jherrod Thomas, Greenville, SC (US)

(72) Inventor: Jherrod Thomas, Greenville, SC (US)

(73) Assignee: Jherrod Thomas, Greenville, SC (US)

(21) Appl. No.: 18/971,544

(22) Filed: Dec. 6, 2024

(51) Int. Cl. B60R 1/12; B60R 1/04; B60R 1/08; G06Q 10/02; G06Q 30/0601; G06Q 50/26

(52) U.S. Cl. CPC B60R 1/12; B60R 1/04; B60R 1/08; G06Q 10/02; G06Q 30/0641; G06Q 50/265; B60R 2001/1223; B60R 2001/1253

(57) ABSTRACT

The present invention relates to an Owl-Smart-Green (OSG) rearview mirror system that enhances driver safety, comfort, and situational awareness. The system utilizes advanced visualization technology to generate and display thermal packets, providing real-time enhanced visibility, especially in challenging conditions. The mirror-display unit seamlessly transitions between traditional rearview mirror and high-tech digital display modes, offering customizable options for different driving scenarios. The OSG system integrates with various input sources, including online platforms, nearby vehicles, and vehicle infrastructure, to deliver real-time information and services. The system also incorporates an integrated assistive sub-system powered by Al to assist the user. By prioritizing user security, privacy, and convenience, the OSG rearview mirror system revolutionizes the driving experience, making it safer, more efficient, and more enjoyable.

### FIELD OF THE INVENTION

The present subject matter relates to a rear-view mirror system, having a plethora of advanced functionalities and modes. Primarily, one of the modes and functionality includes, providing visual information beyond the ordinary human visual perception. Further a secondary mode and capability includes Al assisted booking and reservation platform that interacts with various types of hospitality industry outlets, based on user preference.

### BACKGROUND OF THE INVENTION

Traditional rear-view mirrors have been a fundamental component of automotive safety for decades. Modern advancements in this technology have led to the development of various smart rear-view mirror systems, including camera-based systems and blind spot monitoring systems. While these systems have improved upon traditional mirrors, they often lack a comprehensive and integrated approach to enhancing driver safety and convenience, especially in low-visibility conditions.

Existing rear-view mirror systems in automotive vehicles often rely solely on visible light, this leads to reduced visibility and potentially dangerous driving situations. Further, the automotive industry has witnessed a relentless pursuit of innovation to enhance safety, efficiency, and driver comfort. One critical area of focus has been the development of rear-view mirror systems, that provide drivers with a more comprehensive and accurate information about their surroundings. Traditional rear-view mirrors often fall short, in providing adequate visibility, especially in low-light/obscured conditions, such as fog, mist, dust storm, rain etc. This leads to reduced situational awareness and potentially dangerous driving scenarios.

There is a growing demand for rear-view mirror systems that provides a more comprehensive and informative view of the surrounding environment. Such systems should be capable of operating effectively in various lighting conditions, offering features like night vision, thermal imaging, and real-time information about traffic conditions, points of interest, potential hazards, hospitality, reservations, booking availability and other known in art business. Additionally, these systems should be user-friendly, intuitive to operate, and seamlessly integrate with other vehicle systems.

Currently, available rear-view systems within the market do not represent any significant advancement over prior systems, especially in terms of providing features such as, a better visual display, user-friendly operational ease, real-time enhanced display/information, including thermal imaging and information regarding the temperature of the objects in the line-of-sight, being a key feature that is missing in all previously available systems. Further, the integration of the system with various other awareness units, such as lidar sensors, GPS sensors, and cameras, that allow the system to provide a comprehensive and informative view of the surrounding environment to the user, are not known/explored within this domain.

Beyond these aforementioned core functionalities, current market available rear-view mirror system does not provide hospitality features like online booking and payment with respect to local businesses, that is a valuable service for users with busy schedules.

No existing rear-view mirror transforms a vehicle into a smart car. While there are systems that are added to vehicles to enhance vision, such as night vision or thermal imaging, these features are typically supplemental and not core components of any rear-view mirror's primary function. Rear-view mirrors are primarily used for reversing and parking, not general driving. There is no system where old rear-view is being replaced by a smart rear-view mirror system, as an automotive accessory upgrade.

Currently no vehicle in the market offers a rear-view mirror system that exclusively relies on Al, chatbots/assistants or any combination of these technologies for its integrated assistive subsystems. Further, they may not offer the full range of functionalities required for a comprehensive rear-view mirror system, such as advanced driver assistance systems (ADAS), real-time traffic updates, or integration with other vehicle components as well as nearby business.

Many commercially available rear-view mirror systems currently lack a robust security infrastructure capable of protecting user data from unauthorized access. This vulnerability poses a significant risk, as the data generated by these systems often includes sensitive information such as location data, driving habits, and potential personal preferences. Without adequate security measures, this data could be compromised, leading to privacy breaches, identity theft, or even targeted attacks. The absence of a comprehensive security framework not only endangers individual users but also undermines the overall trust in advanced automotive technologies.

The automotive industry has witnessed significant advancements in recent years, with a focus on enhancing safety, efficiency, and driver comfort. One area of particular interest is the development of rear-view mirror systems that provide drivers with comprehensive and intuitive information about their surroundings.

To address these limitations, the present innovation focuses on a unified mirror system, by simplifying the driver's experience and contributing to overall road safety.

In conclusion, the present subject matter provided below intents to address the limitations of traditional rear-view mirrors by offering multiple functionalities in a single device, by providing a comprehensive, informative, integrated and user-friendly solution. Its unique combination of features, such as, including but not limited to, enhanced visualization, real-time information, and integrated services, make it a novel and innovative contribution to the field of automotive technology.

### SUMMARY OF THE INVENTION

The present subject matter relates to an Owl-Smart-Green (OSG) rearview mirror system, comprising at least one enhanced visualization unit that generates thermal packets. These thermal packets provide information about temperature differences between various objects in the environment. The processed thermal data is then displayed on a mirror-display unit, providing real-time enhanced display. The OSG rear-view mirror system further processes digital packets obtained from various input sources to enhance safety, comfort, and situational awareness. This cutting-edge system seamlessly integrates advanced visualization technology, intelligent communication capabilities, and user-friendly features to provide a comprehensive solution for modern drivers.

In any embodiment, the enhanced visualization unit generates thermal packets to detect heat difference between object in the environment and present a real-time enhanced display on the mirror-display unit, even in challenging conditions like fog, smoke, or darkness. This significantly improves visibility, enabling drivers to react promptly to potential hazards and navigate with confidence.

Further in any embodiment, the mirror-display unit is a versatile tool that seamlessly transitions between a traditional rearview mirror and a high-tech digital display. This adaptability empowers drivers to select the optimal display mode for any driving situation: Owl Mode: Prioritizes thermal imaging for enhanced visibility in low-light conditions. Smart Mode: Offers a comprehensive display of information, including navigation, entertainment, and vehicle diagnostics. Green Mode: Operates as a traditional rear-view mirror.

Furthermore, the OSG rear-view mirror system seamlessly integrates and communicates with various input sources, including online platforms, nearby vehicles, and vehicle infrastructure to generate digital packets. By leveraging advanced communication technologies, the system delivers real-time information and services directly to the user. These packets provide information about nearby businesses, payment services, booking, alerts, and amenities, enabling drivers to plan their journeys efficiently. These packets gather data from various awareness units/sensors to provide real-time information about the surrounding environment, including traffic conditions, weather alerts and potential hazards.

The mirror-display unit boasts several innovative features. It offers mode-switching capabilities based on the environmental conditions and user preference, allowing users to select their preferred mode through manual switching and/or user packets. Additionally, the unit can be easily detached and reattached, providing flexibility and convenience for users who may wish to take it with them. To enhance visibility and replace traditional car interior lights, the mirror-display unit incorporates integrated lighting lamp.

Furthermore, the OSG rear-view mirror system includes an integrated assistive sub-system that leverages Al to assist the user. The system also prioritizes user security and privacy by incorporating robust security measures to safeguard sensitive information.

By combining these innovative features, the OSG rear-view mirror system empowers drivers to navigate the road with confidence and ease. It enhances safety, improves comfort, and streamlines the overall driving experience, making it a valuable asset for drivers in today's connected world.

### ADVANTAGES OF THE INVENTION

The OSG rear-view mirror system significantly improves road safety by offering drivers a comprehensive view of their surroundings, regardless of adverse weather conditions. This is particularly beneficial in situations with limited visibility, such as fog, rain, or darkness. By providing a clear and unobstructed view of the road ahead, the OSG system enables drivers to identify potential hazards early on, allowing them to react promptly and avoid accidents. This enhanced situational awareness contributes to a safer driving experience for both the driver and other road users.

Improved visibility is a key advantage of thermal packet. Unlike traditional mirrors, which rely on visible light, thermal imaging units detect heat emitted by objects. This allows them to see in darkness or through conditions that obscure visible light, such as fog, smoke, or darkness. For example, a thermal imaging unit is capable of easily identifying a pedestrian or animal crossing the road, even if they are partially hidden behind trees or bushes. Similarly, small objects on the road, such as debris or potholes, are detected more readily with thermal imaging, reducing the risk of accidents.

The OSG rear-view mirror system significantly enhances a driver's awareness of their surroundings, thereby mitigating the risk of accidents. By providing real-time data on traffic conditions, road closures, and potential hazards, OSG rear-view mirror system empowers drivers to make informed decisions and adjust their driving accordingly. This heightened awareness enables drivers to anticipate potential dangers, maintain safe following distances, and navigate through congested areas more efficiently, ultimately contributing to a safer driving experience. The system provides users with a more comfortable and enjoyable driving experience by reducing stress and anxiety.

The thermal imaging technology in the OSG rear-view mirror system provides a clear view of the environment, even in conditions where traditional mirrors struggle. This is especially beneficial during night-time, foggy conditions, or, even when facing glare from oncoming headlights/Sunlight. Further, the system is capable of detecting objects that may be obscured from view in traditional mirrors, such as pedestrians, animals, or small objects on the road. This proactive detection helps prevent accidents and ensure driver safety.

The OSG rear-view mirror system offers multiple display modes, allowing drivers to choose the view that best suits their needs and preferences. This customization enhances the overall driving experience and reduces distractions. The smart-mode functionality integrates with various online sources and hospitality infrastructures, providing drivers with convenient access to information and features like Google Assistant, maps, and shopping options. This helps to reduce user fatigue and improve overall comfort. Furthermore, the system offers owl-mode for improved low-light visibility and thermal imaging for detecting hazards in fog or smoke. The green-mode is primarily for eco-friendly information.

The thermal imaging technology, is further optimized to provide even better night vision capabilities, enabling drivers to see objects in complete darkness. The system could be integrated with advanced driver assistance systems (ADAS) to provide real-time warnings and potential braking assistance to avoid collisions. The thermal imaging technology could be designed to be energy-efficient, minimizing the impact on the vehicle's battery life. Additionally, allows control features like navigation, calls, and music without taking your hands off the wheel. The system warns you of potential hazards like weather conditions or traffic jams through voice alerts. Find and book hotels, restaurants, gas stations, or other services directly through the mirror. Pay for bookings securely without fumbling with cash or cards. Access Google Assistant or other virtual assistants for a variety of tasks like playing music, making calls, or controlling smart home devices.

In conclusion, the OSG rear-view mirror system represents a significant advancement in automotive technology. By combining thermal imaging technology with advanced display modes and smart device integration, it offers a comprehensive solution for enhancing driver safety, visibility and overall driving experience. As technology continues to evolve, we expect to see even more innovative and sophisticated rear-view mirror systems in the future.

### BREIF DESCRIPTION OF THE DRAWINGS

The summary above, as well as the following detailed description of illustrative embodiments, is better understood when read in conjunction with the appended drawings. For the purpose of illustrating the present subject matter, exemplary constructions of the subject matter are depicted within the drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following Drawings, wherein:

FIG. 1 Illustrates an implementation of an OSG rear-view mirror system, specifically, the major unit known as mirror-display unit. FIG. 1A discloses a perspective view of the mirror-display unit, FIG. 1B depicts a front view of the mirror-display unit, FIG. 1C is an orthogonal view of the mirror-display unit and FIG. 1D shows an exploded view of mirror-display unit.

FIG. 2 Illustrates an implementation of an OSG rear-view mirror system, specifically, the major unit known as mirror-display unit. FIG. 2A discloses a perspective view of the mirror-display unit, FIG. 2B depicts a front view of the mirror-display unit, FIG. 2C is an orthogonal view of the mirror-display unit and FIG. 2D shows an exploded view of mirror-display unit.

FIG. 3 Illustrates an implementation of an OSG rear-view mirror system, specifically, the major unit known as mirror-display unit. FIG. 3A discloses a perspective view of the mirror-display unit, FIG. 3B depicts a front view of the mirror-display unit, FIG. 3C is a side view of the mirror-display unit and FIG. 3D shows an orthogonal view of mirror-display unit.

FIG. 4 Illustrates the enhanced visualization unit. Specifically, FIG. 4A discloses the enhanced visualization unit integrated within the head-lamp of the vehicle, FIG. 4B depicts enhanced visualization unit coupled to the front end of the vehicle, FIG. 4C discloses the enhanced visualization unit coupled to the head-lamp of the vehicle and FIG. 4D illustrates an enhanced visualization unit combined with the mirror-display unit.

FIG. 5 Illustrates the Owl-mode of the OSG rear-view mirror system, that is displayed on the mirror-display unit. Specifically, FIG. 5A discloses a mirror-display unit displaying Owl-mode presenting enhanced visual display of a highway identifying objects not visible to the driver's vision and FIG. 5B a mirror-display unit displaying a scene in real time with the help of Owl mode.

FIG. 6 Illustrates the Smart-mode of the OSG rear-view mirror system displayed on the mirror-display unit, presenting a scenario to highlight the feature of the Smart-mode. Specifically, FIG. 6A discloses a mirror-display unit displaying a hotel booking website for user's easy access and FIG. 6B a mirror-display unit displaying user on a call.

FIG. 7 Illustrates the Green-mode of the OSG rear-view mirror system, that is displayed on the mirror-display unit. Specifically, FIG. 7A discloses a mirror-display unit displaying the rear view and FIG. 7B a mirror-display unit displaying rear view.

FIG. 8 Illustrates the OSG rear-view mirror system coupled to a 2-wheeler. Specifically, FIG. 8A discloses a mirror-display unit coupled to the handle of the 2-wheeler and FIG. 8B illustrates a mirror-display unit, that is displaying a map to guide the user.

### DETAILED DESCRIPTION

The present subject matter is a novel device designed to enhance driver safety, awareness, hospitality and visibility. By integrating enhanced visualization unit, the OSG rear-view mirror detects heat signatures, providing a clear view of objects and/or people, during low-light and/or adverse weather conditions. This feature is particularly valuable in challenging environmental/surrounding conditions, with respect to a vehicle.

The OSG (Owl-Smart-Green) rear-view mirror system is a sophisticated system and method, designed/devised to enhance the ordinary rear-view mirror's visibility and to provide a significantly advanced range of smart/intelligent functionalities. Primarily the system incorporates, an advanced visualization unit, that is capable of generating thermal packet/s, with the help of enhanced visualization unit, displaying/presenting a real-time enhanced display. This enhanced display provides users, with an informative and more comprehensive view/information, regarding their surroundings, particularly during low-light and/or adverse weather conditions. The enhanced visualization unit, forms a crucial component of the disclosed system, that is capable of detecting objects and/or life-forms even during scenarios, such as but not limited to, fog, darkness, night-time, smoke, rain, leaves, and/or a plethora of other windshield/view obscuring conditions/scenarios. The thermal packets that have been detected/captured by the enhanced visualization unit is processed by a processing unit and subsequently rendered by a graphics processing unit, in one embodiment of the present subject matter, to generate a processed output. This processed output is then displayed/presented on the mirror-display unit, providing a real-time enhanced display based on the data/information within the thermal packets, as analysed/determined by the various algorithms utilised by the processing unit and the graphics processing unit.

Beyond its core function of improving rear-view visibility, the OSG (Owl-Smart-Green) rear-view mirror system is equipped with advanced communication capabilities. The system is capable of connecting to various input sources, including but not limited to, user devices, online platforms, nearby vehicles, and hospitality infrastructures. This connectivity allows the system to generate digital packets, providing users with valuable data/information and/or services.

Digital packets are categorized into user packet and Intelligence packets, wherein the user packets are data/information gathered from users within the vehicle, further categorized into audio and video packets. Audio packets capture user inputs like voice commands, speech, and other sounds. They are then processed by the mirror-display unit to conduct voice/speech-analysis to interpret the commands, in order to respond intelligently with respect to the user desires/requests. Video packets record visual information from inside or outside the vehicle, providing supplementary data for analysis and context understanding. In some embodiments, video packets particularly record/analyse the user/driver, and even perform tasks, based on user gestures, that are captured visually, via a IR camera, for instance.

Further, Intelligence packets within the OSG (Owl-Smart-Green) rear-view mirror system, are data/information gathered from online sources and/or hospitality infrastructures, these are categorized into hospitality and/or awareness packets. Hospitality packets contain information about nearby businesses, services, and amenities, such as restaurants, hotels, gas stations, and medical facilities. This information is sourced from online platforms and hospitality infrastructures, enabling users to conveniently access and utilize these services. Awareness packets are generated by a variety of awareness units/sensors and systems, including LIDAR, navigation sensors, barometers, hygrometers, light sensors, noise sensors, cameras, thermal sensors, infrared sensors, RADAR, climate sensors, sonic sensors, infrasonic sensors, audio-video sensors, ECUs, infotainment systems, driver monitoring systems, and/or their combinations. These packets provide the system with real-time data about the surrounding environment, enabling it to assist users with navigation, safety, and other relevant tasks.

Furthermore, the hospitality packets, includes data/information obtained from online sources, via the use of smart apps, wherein the smart apps are related to any business apps, such as but not limited to, parking, booking, payment, reservation, vacancy, comparison of features and prices of hospitality infrastructure. This feature could be beneficial for drivers seeking rest stops, accommodations, or other hospitality services during their journey/drive. For example, the system could provide information about nearby restaurants, hotels, or gas stations, and allow users to book reservations or make payments directly through the system.

Additionally, hospitality packet provides capability for user to book vacancies at nearby businesses directly through the system/method disclosed herein. This integration simplifies the process for drivers to find and reserve accommodations or other services, without leaving their vehicle and/or while on move. For example, the system could provide a list of available hotels/motels or restaurants within the area, and allow users to make reservations with extreme ease.

To enhance the booking process, the smart mode integrates with various online booking platforms. This integration allows for seamless transactions and access to a wider range of options for users. For example, the system could integrate with popular booking platforms, providing users with a vast selection of accommodations and/or other services. Thus, adding another layer of convenience, the capability for users to pay for bookings directly through the device, makes this an invaluable feature. This eliminates the need for cash or card payments, streamlining the booking process and reducing potential inconveniences, that are encountered otherwise.

To facilitate communication with online sources and hospitality infrastructures, the OSG system incorporates a variety of communication units. This versatility ensures seamless connectivity with user devices, online platforms, nearby vehicles, and hospitality infrastructures, allowing users to access and utilize various services and information.

The OSG rear-view mirror system offers multiple modes of display, in order to, cater to a wide-variety of user preferences and/or needs, automatically: Firstly, owl-mode, is a mode that displays a real-time enhanced display, providing information regarding the difference in temperature of the objects, night-vision, active-illumination in the environment. This is particularly useful for identifying potential hazards or obstacles, such as pedestrians or animals, that may be difficult to see in low-light conditions by the driver. Secondly, smart-mode is a mode, where the system enables the rear-view mirror to be used as a conventional hand-held smart device, that has access to a plurality of apps which further enable the system to transmit and/or receive intelligence packets, from various input sources. This enhances the driver's experience by providing convenient access to various services. Lastly, green-mode allows the OSG rear-view mirror system to turn off all electronic functions, in order to act as a traditional rear-view mirror, found in any conventional vehicle, helping conserve energy when not being actively utilised.

Owl-mode primarily displays thermal packet data/information and does not require any internet access to operate. The thermal packets originate from the enhanced visualization unit containing valuable data/information regarding the gradient/difference between the temperature of the objects within the vicinity of the enhanced visualization unit. This feature is particularly useful for detecting potential hazards/obstacles, especially in low-light and/or adverse weather conditions. For instance, the system utilizes thermal imaging to identify pedestrians/animals that might be difficult to see in the dark, in urban environments.

In the smart mode majorly, there are two types of packets, audio/video packets and intelligence packet. The audio/video packets are only used for interaction with the user in the vehicle. This enables the system to incorporate real-time information from the user, potentially enhancing the overall user experience and safety. For example, the system utilises audio input, to activate at voice commands and/or actively listen for alerts, from the driver and/or passengers, as per the user preferences. Video input is utilised to capture and analyze the surrounding environment, providing additional information for the user.

Additionally, an automatic and a manual, mode switching option, allows the user to adjust the display mode based on user preferences, and even enabling hands-free access to various features of the system, in some embodiments of the present subject matter. This adaptive feature enhances the usability and relevance of the system, in various driving scenarios.

Lastly, the OSG rear-view mirror system incorporates additional features, such as detachable coupling, integrated lighting lamp, integrated assistive sub-system and a security sub-system. The detachable coupling feature allows users to easily remove and reattach the mirror-display unit to their vehicle, providing flexibility and convenience. The integrated lighting lamp enhances visibility in dark conditions, ensuring user safety. The integrated assistive sub-system is any form of Al, that assists the user as preferred. The security sub-system protects user data generated by the system during operation from unauthorized access, ensuring privacy and confidentiality.

Ultimately, the OSG rear-view mirror system enables detachable coupling in-between the mounting unit of the vehicle body and the mirror-display unit providing flexibility and portability. Allowing users, the ability to freely take the device with them, allowing access to data/information outside the vehicle and customized usage according to their preferences.

This OSG rear-view mirror system enhances driver's capabilities by offering a suite of advanced features. These include intuitive user interfaces for effortless navigation and control, hands-free driving capabilities, convenient in-car booking and reservation options, enhanced visibility in challenging conditions like snow, identification of various vehicle heat sources, and real-time detection of pedestrians in the surrounding area.

Definitions of the terms used:

For purposes of the detailed description of the preferred embodiments, the following definitions are used:

Throughout the present subject matter, the term “OSG (Owl-Smart-Green) rear-view mirror system” refers to a system that enhances the information available to a user, based on the surroundings, it displays real-time enhanced visual information on-demand and provides the user, with various other capabilities. The system primarily comprises of two major units, wherein one of these units is essentially a mirror-display unit, while the other unit is an enhanced visualization unit. In some embodiments of the present subject matter, the system incorporates other additional components, awareness units/sensors, sub-systems, architectures, etc. Primarily, the system offers enhanced visualization of the road ahead, improving the user's visual perception by providing a clear view of all objects in the filed-of-view and especially any kind of lifeforms in the line-of-sight, even in adverse visual conditions, such as, fog, smog, smoke, or other visual obstructions, with the help of a plurality of real-time thermal packets obtained from the enhanced visualization unit, making it particularly valuable in visually-challenging environments, for users to perceive the actual road conditions in front of the vehicle. Particularly, the system is capable of generating a real-time enhanced display based on one or more input sources, including at least one set of real-time thermal packets obtained from the enhanced visualization unit, in order to provide information essentially, regarding the temperature differences between objects in the environment/vicinity/field-of-view of the vehicle, on a mirror-display unit. Further in another embodiment of the present subject matter, the system is capable of communicating with other input sources, that generate other kinds of digital packets, apart from the thermal packets. The mirror-display unit comprises a processing unit that processes packets from these various input source, and a graphics processing unit to process the output of the processing unit, in order to present this enhanced display, to the user as desired/preferred. Secondarily, the system receives and displays information from various input sources, online sources, hospitality infrastructures, applications, websites, internet, servers, etc., allowing the user to access pertinent essential information, as per user desire/preference. This includes information about environmental conditions, business availability, infrastructure, bookings and other relevant alerts, as per the user preference/desire. By integrating these multiple functionalities into a one-stop solution, the system simplifies the user experience and contributes to enhanced overall road safety and digital dexterity, with its plethora of hands-free interaction options and provides similar functionality to an ordinary hand held-smart device. Tertiarily, the system functions as a conventional rear-view mirror, as those found in traditional vehicles, based on user preference/desire. Alternatively, rear-view mirror can work as a modern digital rear-view mirror, wherein the system comprises a camera behind it and update the user. Further, in any of the embodiments of the present subject matter, the system utilizes the mirror-display unit to present owl-mode on demand to the user, that presents a real-time enhanced display, by segregating information based on the temperature differences between the various objects within the line-of-sight of the vehicle. Furthermore, the mirror-display unit switches to smart-mode on demand of the user, wherein the mirror-display unit functions as a conventional hand-held smart device encompassing multiple smart apps/applications/firmware/software, that enable the transmission and reception of intelligence packets from various input sources. Moreover, in any of the embodiments, the mirror-display unit includes an assistive subsystem to assist the user. Additionally, the mirror-display unit incorporates a security subsystem to restrict, any unauthorized users from accessing the user data and/or the system. Lastly, the mirror-display unit features a versatile integrated lighting lamp that replaces the vehicle's conventional interior lights. For e.g., in some embodiments of the present subject matter, the system goes as far as even, utilising the in-place power supply for the previous interior lighting unit of the vehicle, for its own functioning partially at least, by powering the mirror-display unit with this in-place power supply after installation in a vehicle or charging its internal storage device. Penultimately, the mirror-display unit offers flexibility and portability, by enabling a quick detachable coupling between the mirror display unit and a portion of itself, namely a mounting unit. Ultimately, a mode switching system enables users to customize the presentation of data/information available on the mirror-display unit, according to their preferences/desires. Most importantly, the OSG rear-view mirror system, enables any ordinary vehicle, to be converted into an enhanced vision capable vehicle, just by installing the system disclosed within the present subject matter, while additionally the system provides advanced smart/automated/intelligent applications/utilities to the user, that help increase the overall safety, experience and ease of driving the vehicle, especially through visually challenging conditions.

Throughout the present subject matter, the term “enhanced visualization unit”, is any suitable unit, that generates a plurality of thermal packet in order for the system to provide real-time enhanced display to the user. The enhanced visualization unit incorporates several other additional components, sub-units, architectures, casing/mounting design, etc, as per the application/preference. The enhanced visualization unit is one of the various sensor units, that provide real-time essential information to the mirror-display unit. This enhanced visualization unit is any unit, such as an image intensification unit, an active illumination unit and a thermal imaging unit, as per the user/system availability/preference. The thermal packets generated by the enhanced visualization unit provide the users with improved situational awareness and safety by enhancing visibility in low-light conditions, highlighting potential hazards, and providing additional information about the surrounding environment, to the user beyond the ordinary human visual capability. This enables clear visibility in low-light/dark conditions, improving driver/vehicle safety and significantly reducing the risk of accidents/hazards due to impaired visual circumstances, as the enhanced visualization unit acquires thermal data, that is imperceptible by the human vision ordinarily. The main purpose, of the enhanced visualization unit, is to provide real-time data capture and transmission, particularly within the Far-Infrared to Near-Infrared frequencies, utilising technologies, such as but not limited to, Enhanced Flight Vision System, Night-Vision Goggles/Devices, Night Optical/Observation Devices, Thermal Cameras, Forward-Looking Infrared, Digital Image Enhancement, AI/ML/RML based real-time image processing,, optical/digital magnification, telescope/binocular vision and other similar optical/imaging technologies that are appropriate in order to serve the functions, as disclosed within the present subject matter. This feature is particularly valuable in rural areas, mountainous regions, jungle/forest areas, pitch-dark conditions, or, even in urban areas with poor road-infrastructure and especially areas where human civilization and street lighting, may be limited or non-existent. The enhanced visualization unit, assists in detecting and acquiring a plethora of heat signatures, by obtaining thermal packets to eventually present the information to the user on the mirror-display unit, allowing users to identify objects and potential hazards that may not be visible to the naked eye of a human, during such circumstances. For example, thermal imaging is helpful for users in spotting animals crossing the road, even during complete darkness. Further, the enhanced visualization unit identifies and helps in highlighting potential hazards, such as pedestrians, animals, or various obstacles, to improve driver awareness and response time. This feature of the enhanced visualization unit, is especially useful in crowded urban areas or during inclement weather conditions. The enhanced visualization unit provides users with a more comprehensive view of the surrounding environment, helping them make informed decisions and to avoid potential hazards. This is particularly beneficial for new drivers, who have less experience of night time driving, or, those drivers who have difficulty in judging distances or speeds. The enhanced visualization unit reduces the risk of accidents by enhancing visibility and providing drivers with real-time information that is necessary, to make safe driving decisions, directly leading to a reduction in traffic fatalities and injuries. The enhanced visualization unit is any night vision unit such as an image intensification unit, an active illumination unit or a thermal unit, in any of the embodiments of the present subject matter. The image intensification unit, amplifies existing light digitally/optically, enabling clear-vision in dusk, dawn, or poorly-lit areas. The active illumination unit, provides a supplementary illumination to ensure a clearer view of the road, especially for situations with insufficient ambient lighting, including in pitch dark situations. The thermal imaging unit, detects heat sources, focusing especially on thermal signatures emitted by all objects/life-forms in the vicinity and is capable of identifying potential hazards or obstacles, even in extremely challenging conditions like, fog, smog, dust-storms, heavy-rain, cloudy, smoke and provides the longest/deepest night-vision range, along with the ability to be able to operate even in complete darkness. The use of enhanced visualization unit by the system, makes the system a valuable asset for enhancing safety and situational awareness in diverse driving environments/conditions. Furthermore, in some embodiments, the enhanced visualization unit is designed for modularity and interchangeability, wherein it enables detachable coupling to the head-lamp/front-end of the vehicle, the mirror-display unit itself, or any combination thereof, providing flexibility in installation and customization. Additionally, the use of at least one enhanced visualization unit is indispensable for the operation of the system of the present subject matter, as it provides one of the most crucial inputs for the mirror-display unit, in order for the system to be able present an Owl-mode as an option of display modes to the user. In any one of the embodiments, at least one of the enhanced visualization units is preferably disposed in the frontal region of the vehicle, facing the direction of travel. Yet, in any of the other embodiments, the enhanced visualization unit is disposed at the bottom of the vehicle, facing the rare view of the travel. Specifically, in yet other embodiments of the present subject matter, the enhanced visualization unit, further includes wireless communication units, in order to wirelessly-relay the generated thermal packets to the mirror-display unit, allowing easy installation of the system, onto any vehicle. More particularly, in yet other such embodiments of the present subject matter, where the enhanced visualization unit is detachably coupled to the vehicle, the unit includes a power source, such as but not limited to, rechargeable/replaceable battery/cells, as the enhanced visualization unit will be mounted anywhere appropriate, on the front portion of the vehicle, while facing the direction of travel. Hence, may lack a power supply from the vehicle battery and/or alternator, in such embodiments. Ultimately, in any of the embodiments of the present subject matter, the enhanced visualization unit replaces the entire headlamp assembly of the vehicle, or, in other instances only a portion of the headlamp assembly, in order to sleekly integrate into the existing headlamp assembly design/casing on the exterior, while replacing one of the front facing light/LED/bulb, within this headlamp assembly while utilising the power source of this replaced light/LED/bulb, for the operation of the enhanced visualization unit. In yet another alternative embodiment, the enhanced visualization unit is a pre-existing component of the vehicle infrastructure as provided by the OEM, wherein this enhanced visualization unit provides thermal packets to the vehicle infotainment system, ECU of the vehicle and/or other known vehicle management systems, further the information is displayed on the mirror-display unit of the OSG rear-view mirror system. Optionally, in any other embodiment, the enhanced visualisation unit, continues to monitor the road, ahead, even if the user is in smart mode and also provide audio alerts in case the user desires to use the mirror-display unit in smart mode, or, rear-view mode.

Throughout the present subject matter, the term “mirror-display unit” refers to a smart device that is definite requisite for the OSG rear-view mirror system, to provide all the features, services and capabilities, as described in the present subject matter. A mirror-display unit is a sophisticated electronic device designed to enhance the rear-view mirror functionality of any vehicle. The mirror-display unit is capable of operating as a traditional rear-view mirror, or, a more advanced presentation unit, such as any hand-held smart device. By incorporating several advanced technologies, various electronic components and various necessary sensors, it provides users with a more comprehensive and informative view of their surroundings in real-time. Hence, the mirror-display unit comprises internal electric/electronic components, such as but is not limited to, memory units, central processing units, graphics processing units, power storage units, modulation units, amplification units, communication units, secondary electronic components, transmitter-receiver units, electromechanical components, audio-video capture devices, microphones, display screen and other necessary components, in order to, be able to perform all the tasks listed within the present subject matter, as well as, to enable all of the features of the proposed system and method, as described within this present subject matter. The mirror-display unit utilised in the present subject matter, incorporates several other additional components, sub-units, architectures, casing/mounting design, etc., as per the desired/application/preferences. The mirror-display unit comprises specialized electronic units designed to process data from various sensors, such as but not limited to, night-vision units, LIDAR, barometer, hygrometer, light, noise, camera, RADAR, climate, sonic, audio, video, or any combination thereof, to create a real-time visually enhanced representation of the scene surrounding the vehicle. These sensors gather data from the surrounding environment, providing a rich and multifaceted understanding of the surrounding context in the form of collected data through the use of the mirror-display unit to the user. These sensors and various internal electric/electronic components work synergistically, to enable the mirror-display unit to perform its various functions, including data acquisition, processing, display/present and communication/interaction with the user. All the real-time collected data is then processed by the unit's internal components, that involve tasks, such as but not limited to, image enhancement, object detection, data fusion, image parsing, real-time analysis, and predictive modelling. Image enhancement techniques are employed to improve the clarity and visibility of the collected data, while object detection algorithms identify and track various objects, such as vehicles, pedestrians, or obstacles. Data fusion and image parsing, techniques combine information from multiple sensors and/or input sources, to create a complete, as well as, significantly accurate picture of the surrounding environment constantly in real-time by analysing/monitoring the surrounding conditions though the plethora of input sources at its disposal, enabling the mirror-display unit to respond instantaneously with regards to the presentation, that is being provided to the user. Predictive modelling is used to anticipate potential hazards or events, based on historical data, current trends and a plethora of customizable user preferences. For example, in some embodiments of the present subject matter, in a scenario, the mirror-display unit predicts the likelihood of a collision with another vehicle, based on the speed and trajectory of the nearby vehicle, or, in another scenario the mirror-display unit warns the driver about potential adverse weather conditions, based on the generated meteorological data from input sources. In the end, processed data/information is subsequently presented on the unit's display screen, that is selected from any of the various display technologies, including but not limited to, Transparent OLED (T-OLED), OLED, LED, TFT, Micro-LED, Holographic Waveguides, Liquid Crystal-based Display (partially transparent LCD), Projection-based Display, Electrochromic Display and/or any other appropriately suitable display technology, as known within the art. These display technologies offer a range of visual capabilities, allowing the unit to present information in a clear, intuitive, and visually appealing manner as per each specific user desire. To enhance its versatility and user convenience, the mirror-display unit in some embodiments of the present subject matter, is configured to be detachably attached to secondary portion of its own portion, namely a mounting unit that is fixedly attached to the vehicle body. This feature allows for greater modularity and portability of the console and data processing portion of the mirror-display unit, enabling users to easily remove and reinstall this portion of the mirror-display unit as desired/preferred. Yet in some other embodiments, such as, in case where the vehicle is a 2-wheeler, the mirror-display unit has further integrated enhanced visualization unit, wherein these two prime units of the system disclosed in the present subject matter, combine to form a single entity/unit in such embodiments, and yet be detachably coupled to portion of the mirror-display unit, namely the mounting unit, that is fixedly attached to the vehicle body during installation of the system, in such scenarios. In these various embodiments, the mounting unit portion of the mirror-display unit, incorporates several supportive components that enable the mirror display unit to be portably/flexibly utilized by the user, these supportive components, such as but not limited to, include, mounting pillar/s, bolt, screw, spring, latch, hook, clamp, hinge, magnetic components, electrical/electronic wiring, lights/LED/bulbs, for nearby/interior illumination, etc. as per the various user preferences. To ensure the durability and reliability in challenging weather conditions, the mirror-display unit is constructed to be fully waterproof, in some embodiments of the present subject matter. This feature makes it suitable for use on open-top vehicles, 2-wheelers and other vehicles that may be exposed to rain, snow, and/or other similar high-humidity exterior conditions. In addition, in yet other embodiments the core functionalities of the mirror-display unit, is capable of integrating with other vehicle systems/subsystems/units, such as the infotainment, tier pressure monitoring, engine temperature monitoring, fuel tank level sensor, navigation, driver assistance provided by vehicle manufacturers and any other similar informative/interactive vehicle systems/subsystems/units known within the art. This integration enables the mirror-display unit to provide more comprehensive and context-relevant presentation to the user, at all times, as per the user desire/preference. Further, the mirror-display unit is equipped with advanced features, such as but not limited to, night vision capabilities, mixed reality interface, touch screen or voice/gesture control functionalities. Night vision technology, enhances visibility in low-light conditions, while mixed reality interface provides additional information, such as traffic signs, lane markings, alerts/warnings about life-forms that are not visible to the user ordinarily in the line-of-sight, or navigation directions, directly onto a display-feed of the current scene in front of the vehicle. Voice/gesture control functionality allows the driver to interact without making physical-contact with the mirror-display unit (except for touch screen and physical button) by using spoken commands, using hand-gestures or even context/location-based operation, freeing the hands of the user for other tasks and/or driving. Furthermore, in any of the embodiments, the mirror-display unit has touch screen control, to enable the mirror-display unit to function as a hand-held smart device, as per the user preference/desire. In any of the embodiments, the mirror-display unit has hands-free control, wherein user is capable of enabling the mirror-display unit to function as a hand-held smart device with the help of user packets. In one of the embodiments, the mirror-display unit has a physical button, in order to enable mode-switching between various modes of the mirror-display unit, as per the user preference/desire. In any of the embodiments, the mirror-display unit is powered either by the vehicle's battery and/or alternator. Additionally, in any other embodiments, the mirror-display unit has its own independent rechargeable power supply, such as but not limited to, Li-Ion, NiMH, Carbon, silicon, and/or other known rechargeable battery/power-storage technologies, as known within the art. Lastly, the mirror-display unit in any embodiment of the present subject matter, is integrated with lighting lamp, that essentially replaces the vehicle's conventional interior lighting system. Penultimately, a mode switching system enables users to customize the mirror-display unit to their preferences, at any time. Ultimately, in some of the embodiments, of the present subject matter, the mirror-display unit has in-built, rear camera and a front camera, wherein the rear camera is used for scene-understanding and for processing the real-time enhanced display, while the front camera is employed primarily for capturing gestures and monitoring the user for cues that determine functionality of the system. For example, in order to determine if an alert/warning to the user, is warranted or not, by tracking the gaze of the user, in order to ascertain whether the user has acknowledged the potential hazard/obstacle. Alternatively, in any other embodiment, the mirror-display unit is capable of connecting with the user mobile to function as any smart device such as, smart watch, tablet and any other smart devices known within the art.

Throughout the present subject matter, the term/phrase “real-time enhanced display” used, refers to the enablement of an enhanced visual display of the real-time scene in the vicinity of the vehicle, by obtaining data/information in an electro-magnetic frequency that is beyond the natural ability of human-vision. This feature helps in providing real-time information regarding the environment surrounding the vehicle, specifically based on any of the thermal packets obtained/generated by the enhanced visualization unit, in order to assist the user in safe and comfortable driving. Hence, this real-time enhanced display completely transforms the driving experience, by providing users with a more comprehensive and immediate understanding of their surroundings, by showing/presenting information, that is beyond the perception of human vision. In other embodiments of the present subject matter, along with the aforementioned thermal packets, other digital packets that are generated by additional input sources, are also utilised, to provide even more detailed information regarding the vicinity surrounding the vehicle to the user. In yet other embodiments of the present subject matter, real-time enhanced display additionally provides/offers intelligent/automatic immediate/urgent visual updates of potential future mishaps, this is crucial for situations where quick reactions are essential, such as avoiding obstacles, or, responding to sudden changes in road conditions. Further, the displays improve visibility in various challenging conditions, for example, since this enhanced display utilises night vision technology, it makes it easier to spot pedestrians (lifeforms) or other hazards, even in low-light environments. In yet some other embodiments of the present subject matter, real-time enhanced display, in combination with AI/ML/RML assisted algorithms/models, offers a range of advanced features, including but not limited to, lane departure warning, plethora of user-defined alerts/warnings, active blind-spot monitoring, detecting nearby vehicles, providing simple visual cues to the user, adaptive cruise control management, traffic sign recognition, helping drivers stay informed regarding speed limits in the vicinity, highlight stop signs, and help the user with other road rules/regulations in that area and even display information regarding nearby businesses, like for example, but not limited to, restaurants, hotels, malls, hospitals, spas, dentists, therapists, parks and any other similar businesses/services, as known within the art, enabling the user to book/reserve and/or avail the services. Provided by these businesses. Most importantly it should be noted that, in any of the embodiments, the real-time enhance display provides a display where the mirror-display unit significantly varies the colour/view of the objects detected by the enhanced visualization unit, in order to enhance the difference in contrast of the various objects with respect to each other while displaying to the user of the OSG system in Owl-mode. In general thermograph the temperature of the objects is shown as is, whereas in the real-time enhanced display the temperature of the objects maybe altered digitally in order to provide a clear difference between the various objects having very close temperature with respect to each other.

Throughout the present subject matter, the terms “input sources” refers to any source that generates digital packets, wherein these digital packets help the user in understanding their environment, wherein the information is derived from a diverse range of sensors, reconnaissance drones/UAVs (unmanned aerial vehicles), systems, internet, servers/platforms, software's/firmware's/programmes/algorithms and a plethora of applications that are appropriate for use, in such scenarios. These input sources include, but are not limited to, enhanced visualization units that provide the majority of the enhanced visual data, other sensors for environmental conditions such as, traditional cameras for visual data, RADAR sensors for detecting moving objects, LIDAR sensors for creating 3D maps using laser beams, sonic/ultrasonic sensors for detecting sound based perception, booking apps and business platforms for nearby service information, thermal imaging sensors for detecting heat signatures, and other plethora of sensors or data packets that are commonly utilised within this field. This comprehensive array of input sources, in some embodiments of the present subject matter, enables the vehicle to gain a thorough understanding of its surroundings, facilitating informed decision-making. Further, these input sources generate digital packets, incorporating intelligent packets and user packets, in order to provide valuable information and insights that enhance the user capabilities, as well as, ease the user while interacting with the system. For example, real-time traffic data, from the internet helps the user to avoid congestion and find the most efficient routes. Weather forecasts enable the user to prepare for adverse conditions, such as rain or snow. And local news provides information about road closures, accidents, or other events that may impact the vehicle's journey. Furthermore, the digital packets incorporate data or information gathered from various online sources through the use of smart apps. These smart apps are capable in connected to various business applications like those used for parking, booking, payment, reservation, checking vacancies, comparing the features, prices of hospitality infrastructure and any other apps known within the art. By leveraging both physical sensors and digital data, the user is capable of effectively navigating complex environments, interact with the surrounding businesses/hospitality infrastructures, and enjoy a safe/efficient driving experience. This combination of input sources allows the vehicle to instantaneously adapt to the ever-changing conditions, anticipate potential hazards, and inevitably assists the user in making intelligent decisions in real-time.

Throughout the present subject matter, the term “online source/s” encompasses any digital information, accessible via the internet. This includes data found on various platforms, such as websites, servers/platforms, social media networks, online forums and smart apps. Regardless of the specificity, if any information/data is available/obtained from online/network, it falls under the category of an “online source.”

Throughout the present subject matter, the term “hand-held smart device” encompasses a broad range of electronic devices, that function as smart devices. This includes commonly known devices, such as, but not limited to, smartphones, tablets, laptops, smartwatches and other wearable smart devices. Additionally, hand-held smart devices, further includes other emerging smart devices, that may be developed or recognized as being the same, in terms of operation, with the aforementioned devices. Thus, the hand-held smart device, incorporates many of the same components, in very similar architectures, as available in any generic/advanced smartphone. Primarily, the mirror-display unit, in many of the embodiments of the present subject matter, imperceptibly similar to a hand-held smart device. Hence, the mirror-display unit in some embodiments of the present subject matter, possess a detachable/fixed transparent/rubber/waterproof/plastic/organic casing/cover, that encases the body of the mirror display unit, in order to physically safeguard the mirror-display unit. Additionally, this casing/cover in some other such embodiments provides cushioning/bracing on the edge/corner portions of the mirror-display unit, to ensure safety of user, in case of any kind of unwarranted collisions with the said unit.

Throughout the present subject matter, the term “smart apps” or “application/s” or just “apps”, refers to applications designed for smart devices, that streamline various activities through the use of various online sources, in order to provide a variety of utilities to the user, similar to a hand-held smart device. These applications offer user-friendly interfaces for tasks such as booking accommodations, making reservations at restaurants, scheduling appointments with professionals, shopping online and a plethora of other similar utilities. They often leverage advanced features like location-based services, notifications and personalized recommendations based on user-data, to enhance the overall user experience and to deliver various services, that are tailored to the preferences of each individual user.

Throughout the present subject matter, the term “hospitality infrastructure/s” refers to physical infrastructures, including a huge variety of hospitality services that are accessible to the user, via the system, of the present subject matter. These hospitality infrastructures that provide services, range from but not limited to, restaurants, hotels, spas, resorts, take-aways, restaurants, diners, amusement parks, events, movies, shows, parking locations, a variety of therapists, beauty/massage parlours, wellness retreats, home-stay/Bed-n-Breakfast accommodations, infrastructures that provide free/cheap Wi-Fi, hardware stores, grocery stores, furniture stores, local/nearby wholesale markets, pharmacy/drug stores, etc., while to the other extreme, alternative hospitality services that are more serious in nature, such as but not limited to, emergency/automotive services, hospitals, medical centres, local police stations/law-enforcement agency, local legal assistance, and other such emergency-based hospitality services, as may be required by the user, based on the scenario and/or user desire/preference. The data/information obtained from these hospitality infrastructures, includes but is not limited to, the availability of parking spaces, seating capacity, vacancies, rating, features, specifications, details, reviews, infrastructure inventory, operating hours, traffic congestion levels, weather conditions, public transportation schedules and other paraphernaliac service information that maybe pertinent to the user, as per the context/scenario and/or user desire/preference.

Throughout the present subject matter, the term “communication unit/s” refers to a unit, that is utilised to establish connections with online sources and hospitality infrastructures. These communication units, are selected from a diverse pool of communication/data-transmission technologies, that includes but is not limited to, Wi-Fi, NFC, NB-IOT, Zigbee, LoRa, CSS (Cluster Switch Systems) Bluetooth, WLAN, Satellite, 5G, 4G, Li-Fi, WAN, PAN, and/or any combination thereof, that enable the system to adequately communicate internally with a plethora of system-units, devices, services, infrastructure, etc., as well as, externally with online sources and/or user smart device, as known within the art. By intelligently selecting the appropriate communication units/technique, the system is capable of effectively interacting with user devices, online platforms, nearby vehicles, and infrastructure, in order to provide smooth operation and seamlessly integration within the communication network formed by the various communication units/techniques. This adaptability to utilise multiple communication techniques, via various communication units, in a multi-level integrated architecture, the system ensures seamless communication and optimal performance in different environments, accommodating the various specific needs and preferences of the user, based on the scenario in real-time. Further, in some embodiments of the present subject matter, the mirror-display unit is capable of communicating user packet/s with other Bluetooth enabled smart devices of the user, such as but not limited to, ear-pods, headphones, smart-watch and other similar wearables smart devices, as known within the art. This feature ensures that the user is able to safely and clearly communicate using voice-commands and/or gestures, with the mirror-display unit, even for example but not limited to, when driving a convertible car with the roof stowed, or, when riding a motor-cycle.

Throughout the present subject matter, the term “user” or “driver” encompasses anyone who is within the vehicle and desires to utilize the system disclosed within the present subject matter, regardless of their role as a passenger, driver, or other occupant. The OSG rear-view mirror system enables that the system's functionality and design are inclusive of all individuals within the vehicle, who may benefit from its plethora of features/capabilities. In any of the embodiments, the OSG system authorizes anyone within the vehicle to utilize the system, considering them as a user/secondary user, wherein the primary user is generally the driver/owner of the vehicle and secondary user is the user assigned by the primary user. Alternatively, in any other embodiment, the primary user is capable of assigning any secondary user the authorization to utilize the OSG system. Further, the term, “User desire/s” or “User Preference/s” denotes a user's expressed intent, or, implied/inferred intent (pre-defined/pre-configured intent, set manually by the user and/or automatically via algorithms), to execute specific actions or tasks within/by any component, unit, device, or, the system as a whole, based on the context/scenario. This encompasses a broad spectrum of actions/commands/gestures, that move the system and in essence the various components forming the system, in order to perform the variety of tasks, that can range from as trivial as, mode switching, asking for weather update, etc., to as complex as, controlling various units under the dominion of the system and/or network resource utilization, in order to perform, for e.g., an online purchase of groceries from an on-the-way grocery store for a drive-thru pickup, recording the live thermal-packets based presentation/display feed of a wild reindeer hiding behind a nearby tree line, etc., all while keeping the hands of the user free and minimizing interaction with the system as much as possible, as is understood based on the plethora of features/applications of the system, as described within the present subject matter. Further in some embodiments of the present subject matter, the user desire/preference may be understood, as the immediate needs of a user in any scenario as it unfolds in real-time, and the system's adaptability to perform as per the pre-defined/programmed/inferred requirements of the user. This involves switching between modes, controlling various system components/units and/or other features/services, based on the user packets. The system is capable of anticipating and fulfilling these desires proactively, by providing a seamless and intuitive user experience. Furthermore, in any of the embodiments of the present subject matter, the user desire/preferences, additionally represents the aspiration of the user, for a one-stop solution, where the entire system works with respect to the user's every requirement in real-time, instantaneously, while managing the processes, such that, the user has to provide minimal gaze/attention towards the mirror-display unit of the system. User preference is something that is said before and desire is his command.

Throughout the present subject matter, the term “vehicle/s” refers any mode of transportation, including two-wheeler, three-wheeler, four-wheeler, multi-wheeler, truck, bus, bicycle, wheel-chair, watercraft and/or any other suitable vehicle, as known in the art. The vehicle includes both personal and commercial vehicle types, as well as those used for transportation on land or water, in context of the present subject matter.

Throughout the present subject matter, the term “owl-mode” refers to a cutting-edge technology that is envisioned, specifically to revolutionize driving experience in low-light, or, low-visibility conditions, by providing the user a real-time enhanced display of the external scenario, surrounding the vehicle. By leveraging advanced thermal/Infrared sensing capabilities, and image processing algorithms, this enhanced mode provides drivers with a significantly enhanced-view that is beyond the capability of the human-eye. Primarily, owl-mode incorporates infrared technology to capture images in dark/low-light, or, visually challenging scenarios. This allows drivers to identify objects and potential hazards, that would be invisible to the naked eye, such as pedestrians, animals, other vehicles, tress, obstacles, road signs, etc. during especially, visually-adverse scenarios where the human-vision is found to be inadequate to safely overcoming the possible object/hazardous situation on the path. By displaying temperature gradients of objects/life-forms within the view in-front of the vehicle, owl-mode helps drivers detect potential obstacles/life-forms, like for e.g. boulders, rocks, logs, animals or people based on the variation of their heat signatures, within a temperature gradient display presentation. This is particularly useful in areas where wildlife is prevalent, such as rural roads, forest roads, national parks and/or other areas, where low visibility, during driving is hazardous due to the terrain, landscape, weather, inclination of the road especially on mountainous roads (for example, when it causes sharp glare of sun-rays), or other such similar occurrences, as known within the art when a driver finds out that relying on just the human eye is inadequate, in order to discern the exact scenario in-front of the vehicle. Further, the image processing algorithms utilised by the owl-mode enhance the visibility of objects in low-light/visibility conditions. This includes improving contrast, reducing noise, and highlighting key details, such as road markings, signs, or other vehicles in the vicinity. Owl-Mode is pre-programmed/pre-defined based on the user-desire, in order to alert/warn the driver, with respect to potential hazards, such as but not limited to, obstacles, potholes, sharp metal objects like nails, boulders, rocks, trees, logs, pedestrians/humans, animals and/or other such potential hazards, that might be difficult to see in low light/visibility scenarios, in turn helping to prevent accidents and improve the overall safety of the vehicle. Enhanced Safety is achieved by utilising this system, as it provides drivers with a clear view/picture of the surrounding vicinity of the vehicle, especially in the forward direction, of travel in real-time or as a live-feed. Owl-mode enables night driving to be less stressful and more enjoyable by increasing visibility and reducing the driver fatigue in such scenarios, leading to a more relaxed and focused driving experience. Owl-mode gives drivers greater confidence in their ability to navigate safely in visually-challenging conditions, reducing anxiety and improving overall driving satisfaction. Owl-mode leverages advanced technologies to provide a comprehensive view of the environment. In some embodiments of the present subject matter, by incorporating an enhanced visualization unit that has a cumulative sensor array that incorporates a multitude of different night-vision technologies, it effectively indents and displays various perspectives of the scene, while reducing power consumption and optimizing the sensors as per the requirement/necessity. For example, in one such embodiment, an image intensification portion of the unit, amplifies low-light conditions, enabling clear visibility in darkness. Then active illumination portion of the unit, emits controlled light to illuminate specific areas, aiding in target identification, as needed. Simultaneously, the thermal imaging portion of the unit, detects and displays heat signatures of everything in the field-of-view, revealing objects and/or individuals based on their temperature, even in pitch black of very adverse visual conditions. This combined approach offers a detailed and informative understanding of the surroundings, in such embodiments, while conserving power, when not in use.

Throughout the present subject matter, the term “smart-mode” refers to a mode that revolutionizes the driving experience by transforming the rear-view mirror, into a multifunctional smart device. By integrating functionalities such as but not limited to, AI/ML/RML based Assistant, navigation maps, online shopping options, etc. by offering the driver a seamless and convenient way to access a wide range of services and information. This eliminates the need for long distractions and ensures that driver remains focused on the road while staying connected and informed. One of the most valuable features of the smart-mode is the ability to assist drivers in finding and booking reservations/accommodations or other similar hospitality infrastructure services directly through the system. This feature is particularly beneficial for those seeking rest stops, food-trucks, hotels, or other similar hospitality amenities/venues during their journeys/trips. By leveraging various online sources, smart-mode provides drivers with real-time information regarding parking-space availability, booking/reservation options, other business specific features and prices of nearby hospitality infrastructures, for instance to name a few options. This allows drivers to make informed decisions and book accommodations or services with ease, without having to leave their vehicle or search for information manually, with the help of the Al assistant, in some embodiments of the present subject matter. Smart-mode, a cutting-edge feature designed to enhance user convenience, by offering a wide range of services tailored to the needs of user on the road. For instance, when a driver seeks a place to stay during a lengthy journey, smart-mode promptly presents a curated list of nearby hotels/motels/home-stay accommodations in the vicinity, complete with detailed information regarding their amenities, availability, and pricing. This enables drivers to effortlessly select a suitable accommodation and book a room directly through the system, saving valuable time and effort. Additionally, if hunger strikes and a driver needs to find a restaurant, smart-mode provides a comprehensive list of nearby dining options, highlighting their cuisines, specialities, extensive menu items, and even customer ratings. User might then choose a restaurant/diner/eatery that aligns with their taste preferences and conveniently make a reservation or order food for take-away directly from within the app on the mirror display unit, within the smart-mode. Moreover, smart-mode extends the services to even encompass other essential needs, such as but not limited to, grocery take-away and other vehicle-based services, offering a one-stop solution for users on the go. In addition to the accommodation and dining assistance features, smart-mode also provides drivers with information about other useful necessary services from time-to-time as may be appropriate, such as gas station, ATMs, electric-vehicle charging stations, etc. and their specific availability/location/rating/costing and other similar attributes. This helps users plan their journeys more efficiently and avoid unexpected delays or inconveniences. Overall, smart-mode is a valuable tool for users, who wish to make the most of their time on the road and enjoy a more convenient and enjoyable driving experience.

Throughout the present subject matter, the term “green-mode” refers to a mode that is very similar to a traditional rear-view mirror, that offers adjustable settings to cater to individual preferences of the user. This mode allows users to utilise the mirror-display unit as a conventional rear-view mirror, while conserving power in this mode, as it does not use any power to function, as is well known within the art. In some embodiments as disclosed in the present subject matter, the OSG system automatically switches, from other modes, to Green-mode based on pre-defined/pre-programmed user preferences, or specific driving conditions/scenario.

Throughout this discussion, the term “digital packet/s” or “packet/s” refer to various types of data/information packets, that include all the types of packets, disclosed within the present subject matter. The type of packet, determines, the type of information/data being transmitted by the various components, units, sub-systems, etc. that form a part of the system, in order to ensure provision of the plethora of functionalities/applications/abilities, as disclosed within this present subject matter, are made available to the user as desired/preferred. Further, the digital packets, are broadly segregated into either of the two major types of packets, or, digital packets within the system, as user packets and intelligence packets. Furthermore, the user packets, is divided into two types of user packets, as audio packets and video packets. While similarly, the intelligence packets, is divided into two types of intelligence packets, as hospitality packets and awareness packets, wherein thermal packets, form a sub-type of awareness packets. All these types of digital packets generally consist of data/information generated/transmitted to-and-fro by/amongst the various different sources included within the system, such as but not limited to, audio-video sensors, input sources, online sources and/or hospitality infrastructures, in order to present the necessary/pertinent data/information, to the user in a visually informative manner, as desired/preferred by the user.

Throughout the present subject matter, the “user packet/s” refers specifically to the data/information that is gathered/obtained from users within vehicle. These user packets are further categorized into two distinct types of user packets, as audio packets and video packets. The audio packets capture a spectrum of user inputs, including but not limited to, voice commands, user-speech, other auditory alerts/noises/sounds. These audio packets are generally processed by the mirror-display unit, in order to, be able to understand and respond to the various user requests/desires/preferences. Similarly, the video packets, on the other hand, record visual information from within the vehicle's interior, or, even vehicle's exterior, providing a supplementary layer of data for analysis and context/scenario understanding by the system. This comprehensive user-data monitoring, enables the system to provide the users of the system, with tailored data/information and other pertinent/desired services. For instance, voice commands from the user, are utilised to initiate navigation applications, adjust settings of the system/mirror-display unit, or make calls, etc. While, gestures are employed to control various in-vehicle functions, such as adjusting the temperature, music volume, selecting/playing/pausing media files, switching between modes, etc. By combining audio and video packets, the system as per some embodiments of the present subject matter, creates a more accurate and immersive user experience. For example, if a user gestures towards a particular destination on a map, the system uses both audio and video data to confirm the intent and based on the inference developed that is based on both these audio and video packets, in order to initiate the navigation application, while inputting the destination as that particular location, as indicated by the user. Similarly, in such embodiments, if a user requests to make a call, the system uses audio data to identify the contact's name to be called, along with the user's voice recognition and video/image data to verify the user's identity through facial recognition.

Throughout the present subject matter, the “audio packet/s” are essentially auditory data/information packets, that convey data/information regarding a user's vocal interactions with the system. These audio packets, are a portion of the user packets, and assist the system in capturing/obtaining auditory data/information, with respect to, the voice commands of a user, in order to, for instance, open apps, search for locations, switch modes, make payments, request assistance, etc., as may be desired by the user. These audio packets act as a conduit between the user's verbal actions and the system's understanding of the user's intention. By analyzing the audio data/information within these audio packets, in some embodiments of the present subject matter the system deciphers the user's intention, emotional state of the user based on the frequency of the tone, and/or the user's immediate need/requirement, in order to respond accordingly. For example, if a user says “open the sunroof,” the system interprets this, voice command from the audio packet obtained and initiates the sunroof opening sequence. This process of capturing, analyzing, and then responding to audio packets, is very essential for creating an overall seamless and intuitive user experience. This method of audio capture and analysis, further enables the system to learn the user's preferences/desires, anticipate their needs, and provide personalized assistance, based on the context/scenario as pre-defined/pre-programmed.

Throughout the present subject matter, the “video packet/s” are essentially visual data/information packets, obtained by the system, that utilises these packets in order to ascertain user gestures for receiving commands/desires/preferences from a user. Video packets are specifically, a portion of the user packets, that are designed to capture and transmit visual information from the user to the system. This entails, monitoring the user's actions, gestures, and/or other visual cues, such as for example, but not limited to, pointing, waving, blinking, snapping, making hand-signs, etc. that provide valuable context for the system, in order to interpret and understand the user's commands or requests. This further includes monitoring the driver for obtaining visual cues, hand-gestures, facial-expressions, body language, eye-lid motion, rate of blinking, gaze-tracking, etc. in order to, make sure that, primarily the driver is conscious/aware at all times, with respect to, any/all potential hazards/obstacles on the road ahead. Secondarily this architecture, helps monitor, warn, alert and/or even record the vicinity of the vehicle, as per the user desire/preference. By analyzing the data/information contained within the obtained/gathered video packets, the system gains a more comprehensive understanding of the user's intent/needs beyond simple verbal or textual input. For example, a user might point at a specific item on a screen, accompanied by a verbal request to “select that.” Then the system combines this visual information from this obtained video packet, with the verbal input to accurately identify and predict the user desire. This ability to capture and interpret visual gestures enhances the user experience by providing a more intuitive and natural way to interact with the system. The video packets play an essential role in enabling the system to respond to user visual inputs, in a more contextual and accurate manner, leading to more efficient and satisfying interaction, with the various components/units and/or capabilities/services of the system as a whole.

Throughout the present subject matter, the term “intelligence packet/s” refers to a portion of digital packets, that are either transmitted to the user by the system directly, or, in other instances indirectly consumed by the system and its various units/components, in order to, provide any specific desired/preferred outcome/service to the user, as per pre-determined/pre-programmed protocols in any given scenario. These intelligence packets serve as a personalized feed of information/data, offering a variety of insights and assistance with regards to almost everything by utilizing the various input sources at the disposal of the system, from for instance, finding a nearby parking spot, to making restaurant reservations, to providing custom in-depth hazard warnings with the help of a thermograph, to automatically contacting emergency services, in case of any kind of a mishap, etc., as understood within the art. By tapping into this wide wealth of information, enabling the user to make informed decisions with a higher degree of confidence, navigate unfamiliar areas/roads with ease, and access local hospitality services effortlessly. These intelligence packets, enable the system, and especially the mirror-display unit in acting as a virtual toolbox, that utilizes data/information from various sources, such as but not limited to, awareness units and hospitality infrastructures. Hence, the two major types of intelligent packets, that are utilised by the system in most of the embodiments of the present subject matter, are awareness packets and hospitality packets. Further, these intelligent packets essentially act as a bridge between the user and the digital world, providing valuable support on the road. For example, in an instance, an awareness packet could provide alerts regarding traffic conditions, road closures, local events, or other pertinent information based on the locality and user desires/preferences, helping drivers stay informed in real-time, in order to avoid any kind of potential disruption of their schedules/plans. Similarly, in another instance, a hospitality packet might include information about nearby hotels, restaurants, and other amusement attractions, making it easier for drivers to plan their trips and find accommodations, while still on the way to that exact location. Furthermore, intelligence packets empower drivers by providing them with the information and tools they need to navigate the road with confidence and significant amount of convenience. By leveraging the power of these specific type of digital packets, drivers enhance their driving experience and make the most of their journey, in other words.

Throughout the present subject matter, the term “awareness packet/s” refers to data/information obtained by a variety of awareness units/sensors, of the system. These awareness units/sensors must include primarily, at least one enhanced visualization unit as a mandatory awareness unit, for the system of the present subject matter to operate as intended by the inventor. Further in other embodiments of the present subject matter, various additional awareness units/sensors of other types are also utilised, including but are not limited to, LIDAR, GPS/NavIC, other navigation assisting units, barometers, hygrometers, light sensors, noise/vibration sensors, cameras, thermal sensors, infrared sensors, RADAR, climate sensors, sonic and ultrasonic sensors, infrasonic sensors, audio-video sensors, infotainment system, vehicle monitoring units (OEM/Retail), driver monitoring unit or any combination of these awareness units/sensors. Furthermore, the data/information obtained from the infotainment system, driver monitoring system, or other similar intra-vehicular monitoring/informative systems, encompasses the acquisition, processing, and analysis of data/information, from various vehicle interior sensors/units, including but not limited to, the air conditioning system, variety of sensors (occupancy sensor, speed-limit sensor, seat-belt sensor, oxygen sensor, etc.), cameras, door locks, and ambient lighting sensors. This data/information is utilized by the system of the present subject matter in some embodiments, in order to provide real-time information, alerts/warnings, and other personalized experiences to the user and/or passengers of the vehicle. Additionally, in some embodiments of the present subject matter, incorporates a highly sophisticated driver monitoring system, designed to continuously assess the driver's physical and cognitive state, through a combination of biometric sensors, facial recognition technology, and behavioural analysis algorithms. This feature enables the system with unique abilities like for instance, early detection of fatigue, distraction, or other potential safety hazards, allowing for timely interventions to mitigate risks and enhance overall driving safety, by providing intelligent suggestions and options, to the user in a timely manner, as deemed appropriate by a pre-defined/pre-programmed protocol. Primarily these awareness packets, provide valuable information regarding the environment and surroundings, such as alerts of potential hazards, warnings of adverse weather conditions, notifications of drastic temperature variations, and many more similar predictive services, as understood within the art. By equipping drivers with this enhanced information/knowledge, awareness packets help them stay informed and prepared for all possible potential challenges on the road, at all times.

Throughout the present subject matter, the “thermal packet/s” are essentially, a specific type of awareness packets, that help the mirror-display unit/system to be able to create a visual representation of a thermal scan in real-time, in very crude terms allowing the user to identify areas or objects, that are hotter or colder, compared to their immediate surroundings. This information is particularly useful in various applications, as it offers valuable insights into the variation of temperature distribution among all objects in any given scenario, enabling the system to make clear distinction between life-forms and other objects, as well as, enabling the user to even visualize life-forms behind another object in some instances, with the help of a real-time thermographic display-feed. It must be noted that, these thermal packets are obtained exclusively from the enhanced visualization unit, within all the embodiments of the present subject matter. Further, for instance, thermal packets are used to locate objects that might not be easily visible under normal lighting conditions, such as un-illuminated, people or animals in complete darkness, or, when obscured by an inclement weather scenario, such as, smoke or fog. In such instances, by providing a clear visual representation of temperature variations, thermal imaging technology offers a valuable tool for enhancing safety, security, and situational awareness, of the user, in such conditions.

Throughout the present subject matter, the “hospitality packet/s” refer, to the intelligent packets, that pertain to data/information collected from various online sources and hospitality infrastructures, via the enablement of various smart apps and a multitude of complex communication networks, that relay a plethora of pertinent data/information, regarding, for example, but not limited to, empty parking slots, online booking/reservation services, on-the-go digital payments/transactions, vacancy/specifications of hospitality infrastructure services and the availability of such services, comparative analysis of similar hospitality infrastructure, as well as, integration with online platforms. In another embodiment of the present subject matter, these hospitality packets offer details regarding nearby amenities, accommodations, and services, making it easier for users to find what they desire, with extreme ease. This data/information is used to provide users with relevant information and services, such as best service options, business open-close status, fast routines, quick appointment/reservation booking, weather forecasts, online payments, seating/dwelling availability, hospitality infrastructure rating/reviews, event passes, infotainment system feed/updates/notifications, driver monitoring system, and a plethora of other similarly pertinent data/information, based on the context/scenario and/or user desire/preference. The term “event passes” refers to tickets, bookings, reservations, appointments, match/game passes, or smart tags/cards/chips that grant access to various kinds of hospitality events, such as but not limited to, concerts, workshops, activities, movies, buffets, sports events, shows, theatre, museums/planetariums and various other similar kind of hospitality events, that need prior reservation/booking, in order to enjoy the best services. Similarly, “seats availability” encompasses information regarding seating capacity in restaurants, hotels, motels, theatres, shows and other variety of hospitality venue types, allowing users to make informed decisions with respect to their individual, dining or entertainment plans. The system, as disclosed in the present subject matter, allows the user to hence easily, collect pertinent data/information regarding any kind of hospitality infrastructure, and further, enable them to book/reserve spots/seats for the user and their party, as desired/preferred by the user, from the comfort of their vehicle seat, without any significant amount of effort on their part in accomplishing this entire task. Furthermore, the booking/reservation feature, includes collecting and in-return sending, nearby businesses like restaurants, hospitals, petrol bunks, gas stations, grocery stores, salons, pet care, police stations, and other relevant establishments, the various requirements/needs of the user, as pre-defined/pre-programed based on the user desire/preference. This above type of hospitality infrastructure services, offers merely a glimpse into the myriads of possibilities, that are enabled by the use of this system, as they demonstrate the versatility of the system, in collecting/providing data/information and services tailored specifically to the variety of user desire/preference. For example, in one instance, the system could help drivers find a nearby hospital, in case of an emergency, or, locate a pet-friendly hotel, on-the-go during an abruptly planned road trip. Additionally, the hospitality packets are used to create personalized recommendations, for drivers based on their individual desires/preferences and habits based on the context/scenario. For example, in another instance, the system could suggest nearby restaurants that match the driver's dietary restrictions, or, recommend hotels that specifically offer such amenities that the user personally values more. This kind of personalized approach helps drivers make informed decisions, while significantly saving their time and effort. In conclusion, the hospitality packets are a valuable tool for users, who need to find information with respect to, nearby amenities, accommodations, and a plethora of other hospitality services, especially on the move, in a road-safe manner.

Throughout the present subject matter, the “integrated lighting lamp” seamlessly incorporated into the mirror-display unit, serves as a versatile tool for enhancing spatial perception and design aesthetics. This innovative approach allows for the integration of various interior lighting systems, including but not limited to dome lights, interior vehicle lights, and light lamps, light bulb, torch, flash light into a unified solution. In any of the embodiments, the integrated lighting is configured on any part of the body. Further, in any of the other embodiments, the integrated lighting lamp is located on any part of mounting unit. Additionally, the integrated lighting lamp has various design forms and shape such as, U shape, dome shape, c shape, diamond shape and any other combination of shapes as per the system design. Specially, the integrated lighting lamp is capable of working as a flash light or torch even when the system is not coupled to the vehicle body, as preferred/desired by the user. By strategically placing and controlling these light sources within the mirror-display unit, designers can create a captivating visual experience that elevates the overall interior ambiance. This integration not only optimizes space utilization but also provides a unique platform for exploring diverse design possibilities, resulting in distinctive and visually striking automotive interiors.

Throughout the present subject matter, the “integrated assistive sub-system” could significantly enhance the driving experience by offering a comprehensive suite of additional features. These features might include voice command interpretation, navigation assistance, natural language processing, large language models (LLMs), speech-to-text functionality, and other innovative capabilities. For instance, the system could utilize voice commands to control various vehicle functions, such as, switching between different modes, making phone calls, sending messages, booking hotels/reservations, obtaining event passes, or playing music. Furthermore, it could provide turn-by-turn navigation, real-time traffic updates, and weather information. To facilitate these functionalities, the assistive subsystem leverages Al assistant tools, chatbots, RML, LLM and CNN based technologies, as well known within the field of Al assistance. Beyond these basic features, the assistive subsystem could also incorporate more advanced capabilities. For example, it could utilize natural language processing to understand and respond to complex verbal requests, such as “Find the nearest Italian restaurant with outdoor seating.” Additionally, LLMs could be employed to provide personalized recommendations based on the driver's preferences and driving history.

Throughout the present subject matter, the “security sub-system”, serves as a crucial background component within the system's architecture, safeguarding the entirety of user data from any kind of unauthorized access. This sub-system employs a multifaceted approach to protect sensitive information, including robust encryption algorithms, VPN networks, secure authentication mechanisms, and a plethora of access control policies. The encryption techniques are applied to scramble data, rendering it unintelligible to those without the appropriate decryption key. The VPN networks mask the IP and the data/information, that is being transferred by/to the user. The authentication protocols ensure that only authorized individuals gain access to the system and its data. The access control mechanisms further restrict access to specific data/information, based on user roles and permissions, preventing unauthorized disclosure or modification. By implementing these security measures, the system aims to maintain the confidentiality and integrity of user data/information, protecting it from any kind of third-party potential breaches and unauthorized access.

Throughout the present subject matter, the “mode switching function” offers users the flexibility to seamlessly transition between the various modes of the OSG rear-view mirror system. This versatility is achieved through both manual and automatic options. Physical mode switching is initiated using physical buttons such as buttons, sliders, knobs, touch, clamps, hinge, touch or through similar other physical methods as known in the art. Further, in automatic method of mode switching, the user may switch mode using audio or video packets. By providing users with the ability of mode switching between different modes, the system empowers them to customize their viewing experience and adjust, the presentation displayed on the mirror-display unit to their personal desires/preferences.

Throughout the present subject matter, the term “detachable coupling” refers to a type of coupling that, allows an electronic portion (presentation, data processing, communication, data storage and/or other electronic components) of the mirror-display unit, to be able to, at the will of the user, detachably connect/disconnect with respect to, the electrical/mounting portion (electrical power supply from vehicle engine/alternator, other necessary wiring, physical mounting structure fixedly attached to the vehicle at the time of system installation) of the mirror-display unit. In one embodiment, enhanced visualization unit is also capable of forming a portion of the electronic portion of the mirror-display unit, significantly enhancing the modularity and portability of the electronic portion of the mirror-display unit, in such cases. By detaching the electronic portion of the mirror-display unit, users gain the flexibility to take the device/unit with them, enabling access of data/information and/or customizing the functionality of the unit/system, beyond the confines/vicinity of the vehicle, if so desired. Further, in some embodiments, where the vehicle is two-wheeler the mirror-display unit enables detachable coupling with the mounting unit of the vehicle body, ensuring protection of the mirror-display unit or the enhanced visualization unit, from theft/vandalism. Furthermore, in other embodiments, the mounting unit (electrical portion of the mirror-display unit) and mirror-display unit (electronic portion primarily) are detachably coupled, to each other, using mechanisms such as, but not limited to, hinges, latch, slot, slide, clamps, magnetic coupling mechanism, magnetic charging port, wireless charging, clips, knobs, brace, vice or other known detachable coupling mechanisms, for temporary coupling, that enable easy and tool-less detachment by user, as desired. This detachable coupling in some embodiments enables data/information transfer between the electronic portion of the mirror display unit of the mirror-display unit and the other components attached to the vehicle and/or form the components of the vehicle.

Throughout the present subject matter, the term “mounting unit” refers to a portion of the mirror-display unit, that forms the electrical portion of the mirror display unit, while configured to support and/or detachably couple to the electronic portion of the mirror display unit. Hence, the mounting unit is a vehicle-integrated component or a detachable accessory that is fixedly clamped onto, or, otherwise secured, to a vehicle-body as desired by the user. In any other embodiment of the present subject matter, the mounting unit is a fixed component of the vehicle, while the mirror-display unit (specifically, the electronic portion of the mirror-display unit) is detachably coupled to this mounting unit (electrical portion of the mirror-display unit). Further, in any embodiment, the mounting unit is being fixedly secured to the vehicle using various methods, such as bolts, screws, nuts, glue, welding, or other conventional techniques. Furthermore, in some embodiments, the mounting unit allows the user to adjust the angle of rotation of the mirror-display unit while they are attached, in order to display/present the data/information on the mirror-display unit in portrait/landscape view, as per the preference/convenience of the user.

In the case, where there are two or more definitions of a term that is used and/or accepted within the known art, the definition of the term as used herein, is intended to include all such meanings unless explicitly stated to the contrary.

In conclusion, by integrating the mirror-display unit, digital packets, and enhanced visualization units, along with a plethora of additional sensing/awareness units, the OSG system emerges as a superior rear-view mirror solution for all user purposes. Its advanced capabilities ensure, efficient operation, user-friendly interface, enhanced safety, and a more comprehensive view of the surrounding environment/vicinity. These combined advantages make the OSG system an invaluable asset for users seeking a safer and more convenient driving experience.

### DETAILED DESCRIPTION OF THE PREFERRED EMBODIMENTS

As disclosed within the present subject matter, an embodiment of the OSG rear-view mirror system, comprises at least one mirror-display unit, wherein the mirror-display unit has two portions in the embodiment, an electronic portion of the mirror display unit, and an electrical portion of the mirror-display unit namely a mounting unit, here. Further, the electronic portion includes, an integrated lighting lamp, and a physical button for initiating mode switching function. Furthermore, the electronic portion comprises, a display screen, in order to present the data/information to the user as desired/preferred.

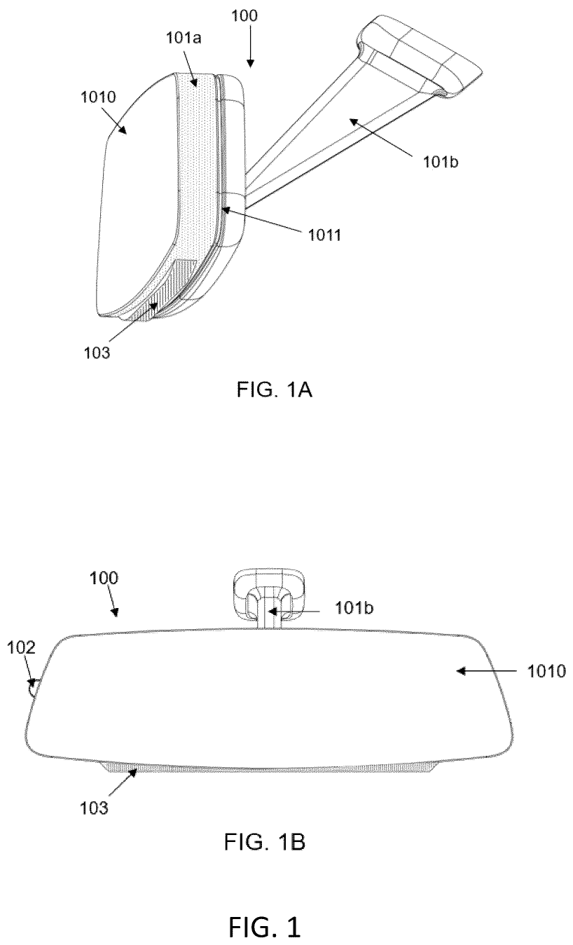

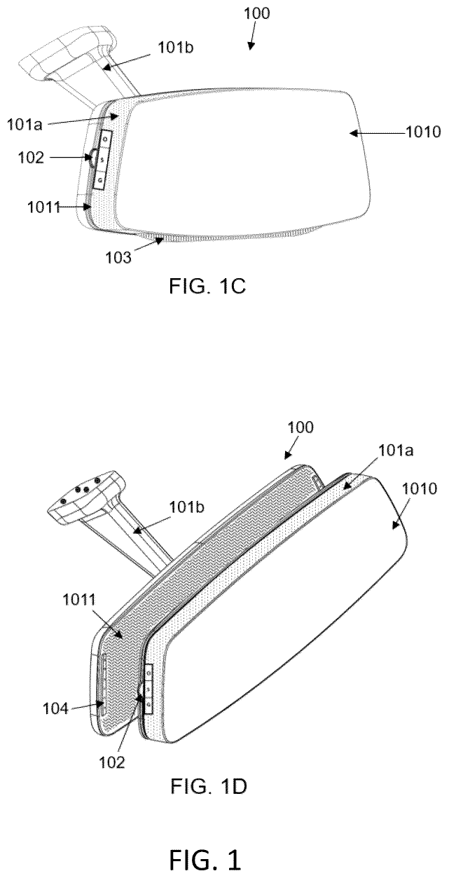

A first exemplary embodiment of a major unit of the OSG rear-view mirror system namely mirror-display unit 100, is illustrated in FIG. 1. The OSG rear-view mirror system includes at least a mirror-display unit 100 comprising an electronic portion 101a, and a mounting unit 101b. The electronic portion 101a is detachably coupled to the mounting unit 101b via a detachable coupling 1011. Further, in this embodiment, the electronic portion 101a includes, a display screen 1010, an integrated lighting lamp 103, and a physical button 102 for initiating mode switching function. However, the mirror-display unit 100 also allows the user, to conduct mode switching with the help of audio and video packets, without any physical contact.

Furthermore, the mirror-display unit 100 as disclosed in embodiment of FIG. 1, comprises an electronic portion 101a detachably coupled to the mounting unit 101b with the help of detachable coupling 1011, wherein the detachable coupling 1011 comprises a magnetic charging port 104, to enable charging/data-transfer between the electronic portion 101a and the mounting unit 101b. In this embodiment, the detachable coupling 1011 comprises a magnetic coupling mechanism.

FIGS. 1A, 1B, 1C and 1D, illustrate a major unit of the OSG rear-view mirror system namely mirror-display unit in various views such as perspective view, front view, orthogonal view and exploded view of an embodiment of the mirror-display unit 100, respectively.

Additionally, the mounting unit 101b, comprises a base portion, wherein the base portion is clamped to the vehicle body using bolt, screw, glue, clip and with other clamping techniques known within the art. Lastly, the mounting unit comprises a supporting beam, to support the weight of the electronic portion 101a.

Yet, in any other embodiment, the integrated light lamp 103 is disposed at any portion of the mirror-display unit, such as but not limited to the base portion of the mounting unit 101b.

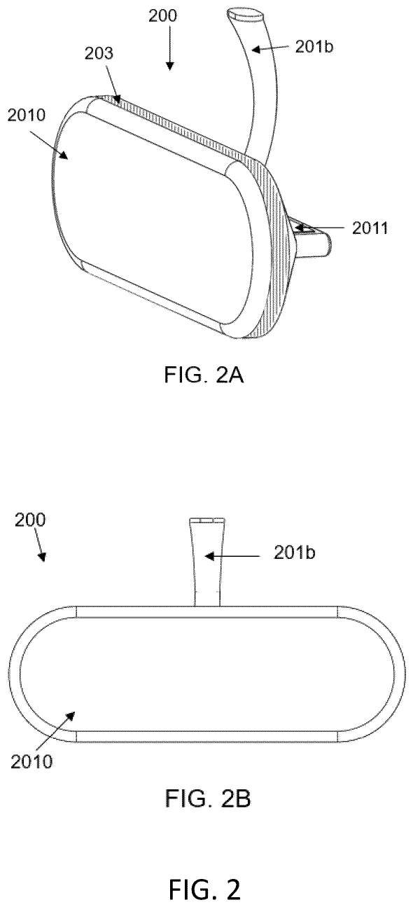

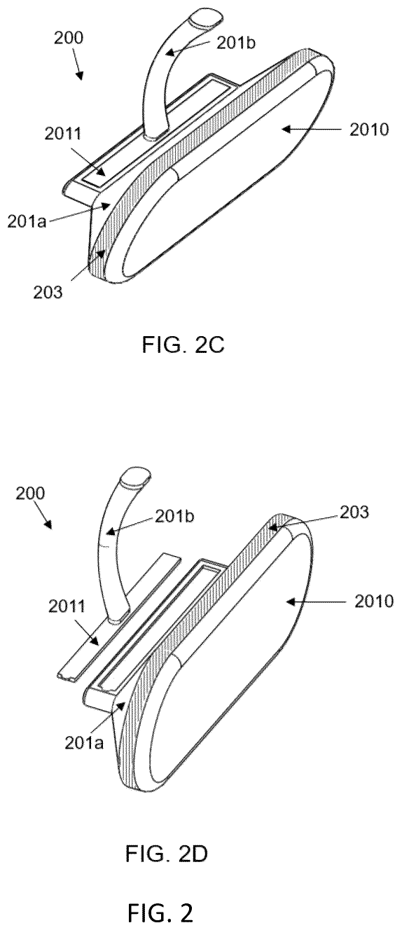

A second exemplary embodiment of a major unit of the OSG rear-view mirror system namely mirror-display unit 200, is illustrated in FIG. 2. The OSG rear-view mirror system includes at least a mirror-display unit 200, comprising an electronic portion 201a, and a mounting unit 201b. The electronic portion 201a is detachably coupled to the mounting unit 201b via a detachable coupling 2011. Further, in this embodiment, the electronic portion 201a includes, a display screen 2010, and an integrated lighting lamp 203.

Furthermore, as illustrated in FIG. 2, the electronic portion 201a of mirror-display unit 200 includes an integrated lighting lamp 203 and a touch display 2010 for initiating mode switching function. However, the mirror-display unit 200 also allows the user, to conduct mode switching with the help of audio and video packets, without any physical contact.

Additionally, the mounting unit of the mirror-display unit 200 as illustrated in FIG. 2, comprises a base portion, wherein the base portion is clamped to the vehicle body using bolt, screw, glue, clip and with other clamping techniques known within the art. Lastly, the mounting unit comprises a supporting beam, to support the weight of electronic portion 201a. In this embodiment, the detachable coupling 1011 comprises a latch/slot/slide mechanism or any other clamping mechanism as known within the art.

FIGS. 2A, 2B, 2C and 2D, illustrate a major unit of the OSG rear-view mirror system namely mirror-display unit in various views such as perspective view, front view, orthogonal view and exploded view of an embodiment of the mirror-display unit 200, respectively.

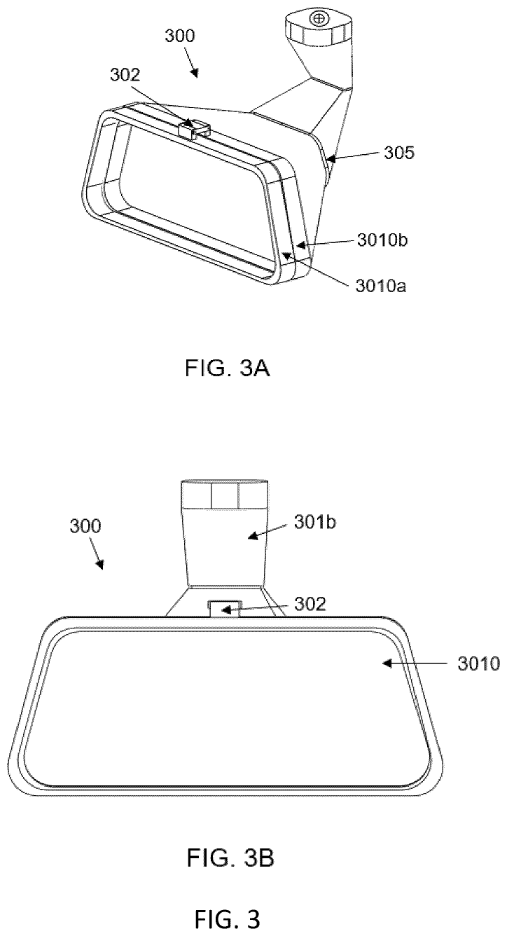

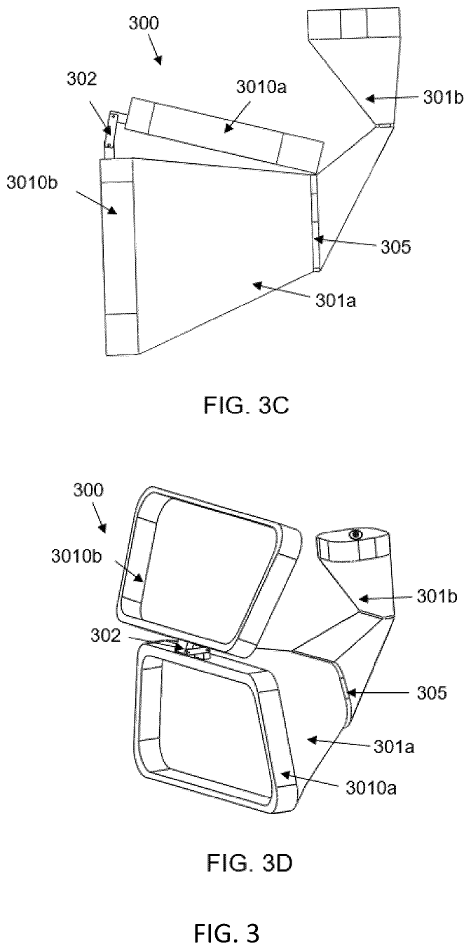

A third exemplary embodiment of a major unit of the OSG rear-view mirror system namely mirror-display unit 300, is illustrated in FIG. 3. The OSG rear-view mirror system includes at least a mirror-display unit 300, comprising, a display screen frame 3010a, a mirror frame, a frame rest 305, and a hinge mechanism 302.

Further, as illustrated in FIG. 3, the hinge mechanism 302 is utilized for initiating mode switching function (in between Greem mode and other modes, specifically.) However, the mirror-display unit 200 also allows the user, to conduct mode switching with the help of audio and video packets, without any physical contact (in between Owl mode and Smart mode, specifically).

Additionally, the mirror-display unit 200 as illustrated in FIG. 3, comprises a base portion, wherein the base portion is clamped to the vehicle body using bolt, screw, glue, clip and with other clamping techniques known within the art. Lastly, in this embodiment, the frame rest 305 allows one of the frames to be rested/supported, as desired/preferred by the user, enabled by the hinge mechanism 302.

FIGS. 3A, 3B, 3C and 3D, illustrate a major unit of the OSG rear-view mirror system namely mirror-display unit in various views such as perspective view, front view, side view and orthogonal view of an embodiment of the mirror-display unit 300, respectively.

Additionally, in any of the embodiments illustrated within FIGS. 1-3, the OSG rear-view mirror system aims to replace the conventional rear-view mirror and interior lighting in vehicles. However, the mounting method for the mirror display unit, is configured in alternative ways, some of which may not be explicitly shown here. In certain embodiments, the OSG rear-view mirror system is designed to allow the mounting unit's leg to extend in various ways, such as telescopically, crisscross, or zigzag, providing flexibility in installation and adjustment. Additionally, in even other embodiment (not shown) the support beam of the mounting unit maybe detachably coupled to the base portion of the mounting unit, and instead be an integral part of the electronic portion of the mirror-display unit, wherein this support beam is utilized as a stand for the electronic portion, when detached from the mounting unit. Lastly, in any embodiment, the integrated lighting lamp is capable of working as a torch when preferred/desired by the user.

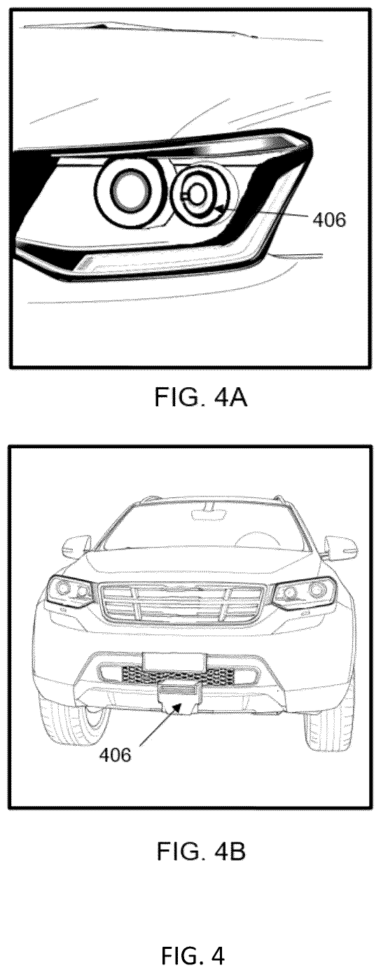

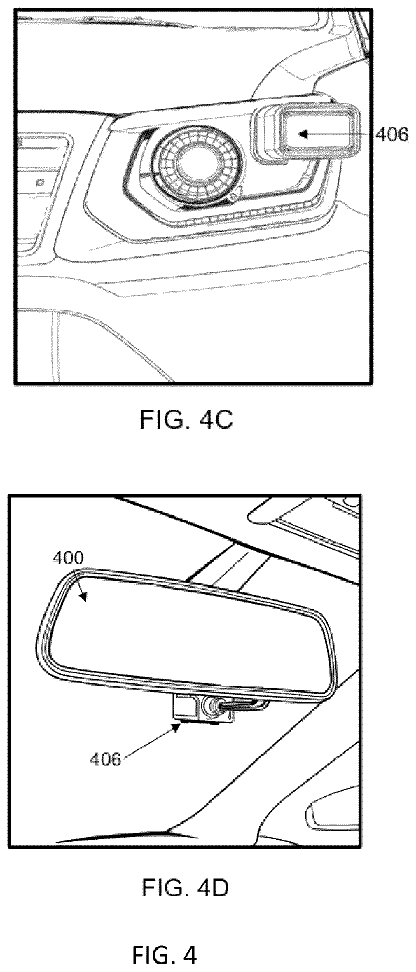

An exemplary embodiment of a major unit of the OSG rear-view mirror system namely enhanced visualization unit 406, is illustrated in FIG. 4

FIGS. 4A, 4B, 4C and 4D, illustrates the enhanced visualization unit, as coupled to various portions of a vehicle body in several different embodiments of the present subject matter.

Specifically, FIG. 4A discloses the enhanced visualization unit integrated within the head-lamp of the vehicle. FIG. 4B depicts enhanced visualization unit coupled to the front end of the vehicle. FIG. 4C discloses the enhanced visualization unit coupled to the head-lamp of the vehicle. FIG. 4D illustrates an enhanced visualization unit combined with the mirror-display unit. Further, in any embodiment, the enhance visualization unit can be integrated at any part of the vehicle as per the user desire.

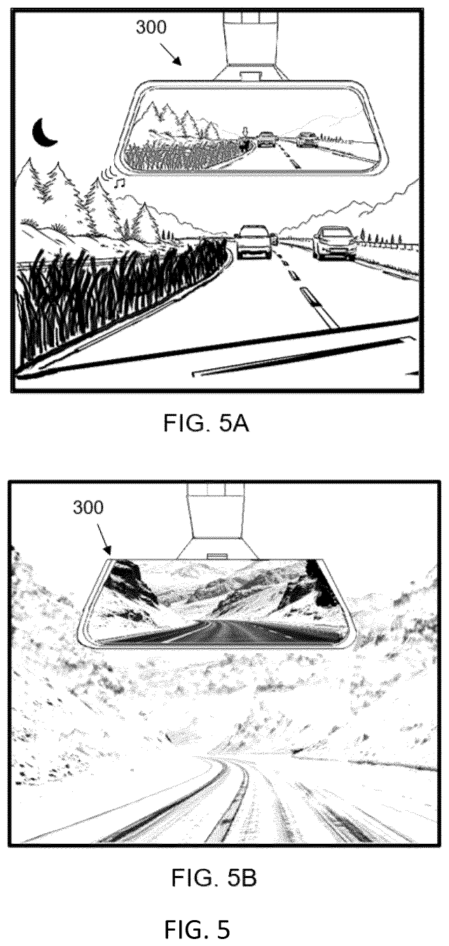

FIG. 5 Illustrates the Owl-mode of the OSG rear-view mirror system, that is displayed on the mirror-display unit.

Specifically, FIG. 5A discloses a mirror-display unit, wherein the unit is in Owl-mode presenting an enhanced visual display of a highway identifying objects not visible to the driver's vision. Here, the mirror-display unit 300 operates in Owl-mode in a night-time scenario, wherein the vehicle is traversing on a highway during low-light conditions. In this scenario, an animal, concealed by the hedges on the edge of the road, obscure the animal due to the dark conditions, posing a potential hazard. The Owl Mode, utilizing a enhance visualization unit of the system, detects objects based on their unique thermal signatures. This enhanced visualization unit generates thermal packets, which are processed and presented onto the screen of the mirror-display unit 300, revealing the invisible animal in contrasting colour/hue. Further, in the embodiment, the system promptly issues a warning alert to the user, along with the visual indicator, such as but not limited to, an arrow, a symbol, a shape, a blinker or other eye-catching digital items, in order to indicate the presence of any kind of obstacle and advising them accordingly to avoid any potential hazards. This timely intervention significantly reduces the risk of accidents, collision and mishaps.

Similarly, FIG. 5B discloses a mirror-display unit displaying another scenario occurring in real time. Here, the mirror-display unit 300 operates in Owl-mode during an adverse weather condition, wherein the vehicle is navigating a snow-covered region with severely limited visibility. In this scenario, the OSG rear-view mirror system, employs an enhance visualization unit, to generate a clear view of objects based on their thermal differences within the field-of-view. In this case, the snow, with its distinct thermal signature, is differentiated from the surrounding environment, specifically the road. Further, this enhanced visualization unit generates thermal packets, which are processed and presented onto the screen of the mirror-display unit 400, in order to provide the driver with a clear view of the road ahead. This enhanced visual display empowers the driver to make informed decisions and navigate safely through the challenging conditions. Most importantly it should be noted that, in any of the embodiments, the real-time enhance display provides a display where the mirror-display unit significantly varies the colour/view of the objects detected by the enhanced visualization unit, in order to enhance the difference in contrast of the various objects with respect to each other while displaying to the user of the OSG system in Owl-mode. In general thermograph the temperature of the objects is shown as is, whereas in the real-time enhanced display the temperature of the objects maybe altered digitally in order to provide a clear difference between the various objects having very close temperature with respect to each other.

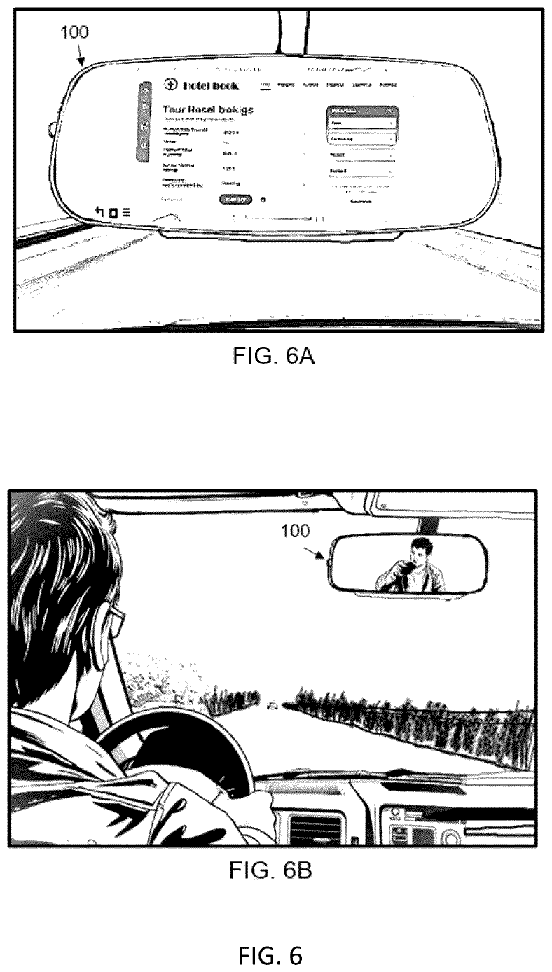

FIG. 6 Illustrates the Smart-mode of the OSG rear-view mirror system displayed on the mirror-display unit, presenting a scenario to highlight the feature of the Smart-mode.

Specifically, FIG. 6A discloses a mirror-display unit displaying a hotel booking website to the user, wherein the mirror-display unit 100, operating in Smart-mode, empowers users with a range of hands-free capabilities, including seamless online booking. By leveraging digital packets, the system efficiently receives user input via user packets and intelligently processes information from intelligence packets to deliver tailored assistance. This groundbreaking technology enables users to effortlessly book hotels, order groceries, or locate nearby hospitals without the need for manual phone operation. This feature is particularly valuable in providing convenience, while ensuring a safe and hazard-free driving experience.

FIG. 6B a mirror-display unit displaying user on a call, wherein the smart-mode extends its functionality to enhance communication while on the road. Users can seamlessly attend calls, participate in meetings, or handle urgent phone calls without taking their hands off the wheel.

Further in any other embodiment, the smart-mode further expands to encompass a wider range of services. This may include grocery booking, real-time hospital availability information, and immediate car service assistance in case of breakdowns. By integrating these services, the OSG rear-view system becomes a comprehensive in-vehicle assistant, providing users with a truly connected and convenient driving experience.

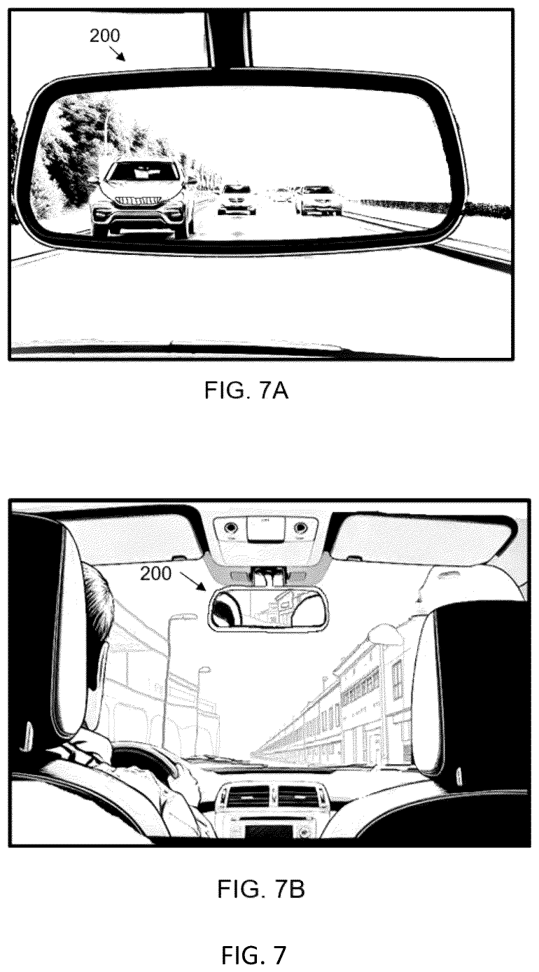

FIG. 7 Illustrates the green-mode of the OSG rear-view mirror system, that is displayed on the mirror-display unit. Specifically, FIG. 7A and FIG. 7B illustrate a mirror-display unit displaying a conventional rear-view.

FIGS. 7A and 7B illustrate the mirror-display unit of the OSG rear-view mirror system in green-mode. The user is capable of switching to traditional rear-view mirror mode as per preference. The system remains highly adaptable, allowing users to effortlessly switch back to the traditional rear-view mirror mode whenever desired, ensuring optimal visibility in various lighting conditions and/or personal preferences. This flexibility empowers users to tailor the operation of the system, to their specific needs and/or various scenarios.

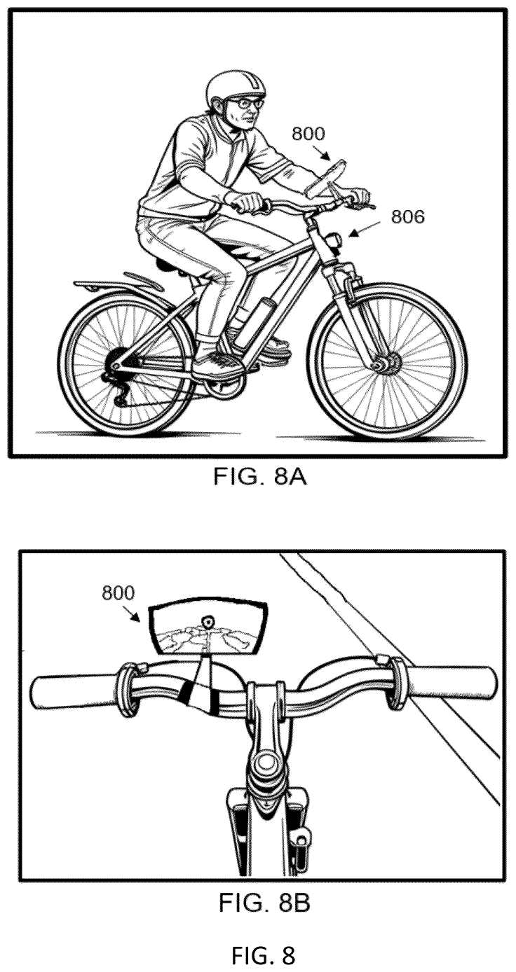

FIG. 8 Illustrates the OSG rear-view mirror system coupled to a 2-wheeler. Specifically, FIG. 8A discloses a mirror-display unit 800 coupled to the handle of the 2-wheeler and FIG. 8B illustrates a mirror-display unit 800, that is displaying a map to guide the user.

The OSG rear-view mirror system, as illustrated in FIGS. 8A and 8B, is configured for seamless integration with two-wheeler vehicles. The core component of the system, here the enhanced visualization unit 806, strategically positioned on the front end of the two-wheeler, offers an unobstructed view of the road. Alternatively, it can be conveniently coupled to the mirror-display unit 800, providing flexibility and portability.

In these embodiments, OSG system is engineered to withstand various weather conditions, thanks to its waterproof design. This robust construction allows for reliable operation, regardless of rain or moisture exposure.

FIG. 8B showcases the system's advanced capabilities, particularly in smart mode. In this mode, a map view is presented to the user, providing valuable navigational information. Additionally, the mirror-display unit incorporates an integrated light system, illuminating the path ahead in low-light or dark conditions. This innovative feature enhances safety and visibility, making the OSG rear-view system a comprehensive solution for two-wheeler riders.

While this specification contains many specific implementation details, these should not be construed as limitations on the scope of any implementations or of what may be claimed, but rather as descriptions of features specific to particular embodiments of particular implementations. Certain features that are described in this specification in the context of separate embodiments may also be implemented in combination in a single embodiment.

Conversely, various features that are described in the context of a single embodiment may also be implemented in multiple embodiments separately or in any suitable sub combination. Moreover, although features may be described above as acting in certain combinations and even initially claimed as such, one or more features from a claimed combination may in some cases be excised from the combination, and the claimed combination may be directed to a sub combination or variation of a sub combination. Below, provided are the claims, of the present invention.

The claims of the present subject matter, as provided below:

1. An OSG (Owl-Smart-Green) rear-view mirror system, comprising:
an enhanced visualization unit, that is capable of generating a plurality of thermal packets; and
a mirror-display unit, in order to present a real-time enhanced display to the user, based on the thermal packets obtained from the enhanced visualization unit.

2. The OSG (Owl-Smart-Green) rear-view mirror system, as claimed in the claim 1, wherein the enhanced visualization unit is at least one of:
an image intensification unit,
an active illumination unit, and
a thermal unit.

3. The OSG (Owl-Smart-Green) rear-view mirror system, as claimed in claim 1, wherein the system is capable of communicating with a plurality of input sources, in order to obtain primarily two types of digital packets, that are selected from the group consisting of user packets and intelligence packets.

4. The OSG (Owl-Smart-Green) rear-view mirror system, as claimed in the claim 3, wherein the intelligence packets consisting mainly of hospitality packets and awareness packets.

5. The OSG (Owl-Smart-Green) rear-view mirror system, as claimed in the claim 4, wherein the awareness packets are generated by a plurality of awareness units, wherein the awareness units are selected from the group consisting of, LIDAR, Navigation sensor, barometer, hygrometer, light sensor, noise sensor, a camera, a thermal sensor, an infrared sensor, a RADAR, a climate sensor, sonic sensor, infrasonic sensor, audio-video sensors, ECU, infotainment system, driver monitoring system and any combination of these awareness units.

6. The OSG (Owl-Smart-Green) rear-view mirror system as claimed in claim 4, wherein the hospitality packets consist of packets collected from a plurality of online sources and hospitality infrastructures.

7. The OSG (Owl-Smart-Green) rear-view mirror system as claimed in claim 6, wherein the system allows the user to make online bookings and purchases as desired.

8. The OSG (Owl-Smart-Green) rear-view mirror system as claimed in claim 6, wherein the hospitality packets are selected from the group consisting of, seating availability, event passes, take-away booking, rating, vacancy at hospitality infrastructure, medical appointment availability, petrol bunk facilities, gas station prices, grocery store inventory, salon appointments, pet care services, police station, emergency services, contact details of nearby businesses, hospitals and other similar hospitality infrastructures.

9. The OSG (Owl-Smart-Green) rear-view mirror system, as claimed in the claim 6, wherein the system includes communication units, in order to communicate with the plurality of online sources and hospitality infrastructures, wherein these communication units are selected from the groups consisting of Wi-Fi, NFC, NB-IOT, Zigbee, LoRa, Bluetooth, WLAN, Satellite, 5G, 4G, Li-Fi, WAN, PAN and any combination of these communication units, in order to communicate with user devices, online platforms, nearby vehicles and hospitality infrastructures, as desired by the user.

10. The OSG (Owl-Smart-Green) rear-view mirror system, as claimed in the claim 1, incorporates multiple modes of display, allowing a user to select between at least one of:
an owl-mode,
a green-mode, and
a smart-mode.

11. The OSG (Owl-Smart-Green) rear-view mirror system, as claimed in the claim 10, wherein the owl-mode displays a real-time enhanced display on the mirror-display unit, based on the thermal packets obtained from the enhanced visualization unit.

12. The OSG (Owl-Smart-Green) rear-view mirror system, as claimed in the claim 10, wherein the green-mode allows the mirror-display unit to functions as a conventional rear-view mirror.

13. The OSG (Owl-Smart-Green) rear-view mirror system, as claimed in the claim 10, wherein the smart-mode allows the user to utilize the mirror-display unit, as a conventional hand-held smart device.

14. The OSG (Owl-Smart-Green) rear-view mirror system, as claimed in the claim 10, further comprises a mode switching function, wherein the OSG system is capable of switching modes based on the environmental conditions and user preferences, as desired.

15. The OSG (Owl-Smart-Green) rear-view mirror system as claimed in claim 1, further comprises an integrated assistive sub-system.

16. The OSG (Owl-Smart-Green) rear-view mirror system as claimed in claim 1, wherein the mirror-display unit offers flexibility and portability to the user, as the mirror display unit is capable of detachably coupling with a mounting unit, wherein this mounting unit is fixedly attached to the vehicle body.

17. The OSG (Owl-Smart-Green) rear-view mirror system as claimed in claim 1, wherein the mirror-display unit has integrated lighting system, for enhancing perception of the user during dark conditions.

18. The OSG (Owl-Smart-Green) rear-view mirror system as claimed in claim 1, further comprises a security sub-system, that prevents user data generated by the system during operation from all types of unauthorized access.
